(19) United States
(12) Patent Application Publication
(10) Pub. No.: US 2022/0161365 A1
(43) Pub. Date: May 26, 2022

(54) MULTI-MATERIAL, MULTI-LAYERED FEMTOSECOND LASER SURFACE PROCESSING

(71) Applicant: NUtech Ventures, Lincoln, NE (US)

(72) Inventors: Alfred T. TSUBAKI, Lincoln, NE (US); Dennis R. ALEXANDER, Lincoln, NE (US); Craig ZUHLKE, Lincoln, NE (US); Jeffrey SHIELD, Lincoln, NE (US); Mark ANDERSON, Lincoln, NE (US); Andrew REICKS, Lincoln, NE (US)

(21) Appl. No.: 17/333,885

(22) Filed: May 28, 2021

Related U.S. Application Data
(60) Provisional application No. 63/031,289, filed on May 28, 2020.

(51) Int. Cl. B23K 26/362

(52) U.S. Cl. CPC B23K 26/362

(57) ABSTRACT

Aspects and embodiments disclosed herein include a method for forming a plurality of microfeatures, the method comprising: irradiating a starting multi-layer material with a pulsed laser beam at a plurality of locations of the multi-layer material; wherein: the starting multi-layer material comprises a plurality of starting layers comprising a first starting layer having a first composition and a second starting layer adjacent to the first starting layer and having a second composition different than the first composition; the plurality of microfeatures form in the multi-layer starting material during the step of irradiating; each microfeature comprises a plurality of microfeature layers comprising a first microfeature layer having the first composition and a second microfeature layer having the second composition. Optionally, each of the first and second composition is an inorganic material.

### CROSS-REFERENCE TO RELATED APPLICATIONS

This application claims the benefit of priority to U.S. Provisional Patent Application No. 63/031,289, filed May 28, 2020, which is hereby incorporated by reference in its entirety.

### STATEMENT REGARDING FEDERALLY SPONSORED RESEARCH OR DEVELOPMENT

This invention was made with government support under FA4600-12-D-9000 awarded by the Office of Naval Research, National Strategic Research Institute. The government has certain rights in the invention.

### BACKGROUND AND SUMMARY OF INVENTION

Femtosecond laser surface processing (FLSP) is an emerging technology for the creation of functionalized surfaces through the formation of self-organized, multiscale surface structures. FLSP is applicable for a wide range of materials, including metals, semiconductors, polymers, glass, and ceramics. The resulting micro/nanostructures provide special surface properties with many potentially useful applications. These include optimizing optical absorption for photovoltaics and photodiodes, altering wetting properties (superhydrophilic or superhydrophobic) for enhanced heat transfer, self-cleaning surfaces, and chemical sensors, and forming surfaces for medical or therapeutic applications. However, there are limitations in terms of the material and structural complexity of surface features typically formed by FLSP processes. These limitations, and others, are addressed herein.

### SUMMARY OF THE INVENTION

Typically, surface structures formed by FLSP are composed out of a single material. Demonstrated herein is the use of starting materials that are multi-material and multi-layered to advantageously produce structures which are composed of material from each layer that are incorporated into each individual self-organized structure, also referred to as “microstructure” herein. These surface structures, or microfeatures, have a range of potential applications. Methods described herein can be used to produce FLSP structures on materials that otherwise could not be structured with FLSP. For example, it is challenging to produce FLSP structures on stainless steel but not on copper, but the methods herein allow for having a layer of stainless steel on top of a layer of copper to initiate the growth of microfeatures on copper.

Aspects and embodiments disclosed herein include a method for forming a plurality of microfeatures, the method comprising: irradiating a starting multi-layer material with a pulsed laser beam at a plurality of locations of the multi-layer material; wherein: the starting multi-layer material comprises a plurality of starting layers comprising a first starting layer having a first composition and a second starting layer adjacent to the first starting layer and having a second composition different than the first composition; the plurality of microfeatures form in the multi-layer starting material during the step of irradiating; each microfeature comprises a plurality of microfeature layers comprising a first microfeature layer having the first composition and a second microfeature layer having the second composition. Optionally, each of the first and second composition is an inorganic material. Preferably, the first microfeature layer of each microfeature is a portion of the first starting layer and the second microfeature layer of each microfeature is a portion of the second starting layer. Preferably, the third microfeature layer, if present, of each microfeature is a portion of the third starting layer, if present, of the starting material. Preferably, the first microfeature layer, or a majority portion thereof, of each microfeature has the same microstructure as that of the first starting layer. Preferably, the second microfeature layer, or a majority portion thereof, of each microfeature has the same microstructure as that of the second starting layer. Preferably, the third microfeature layer, if present, or a majority portion thereof, of each microfeature has the same microstructure as that of the third starting layer, if present.

Optionally, in any method, microfeature(s), composition, material, and system disclosed herein, the second microfeature layer is directly adjacent to or contiguous with the first microfeature layer. Optionally, in any method, microfeature(s), composition, material, and system disclosed herein, the second microfeature layer is separated from the first microfeature layer by an interfacial layer having a thickness less than 10 μm. Optionally, in any method, microfeature(s), composition, material, and system disclosed herein, the plurality of starting layers comprises a third starting layer adjacent to or contiguous with the second starting layer and having a third composition different than each of the first composition and the second composition. Optionally, in any method, microfeature(s), composition, material, and system disclosed herein, each of the plurality of starting layers or each of the plurality of starting layers other than the first layer has a thickness selected from the range of 1 μm to 1000 μm, optionally any thickness therebetween inclusively, optionally selected from the range of 1 μm to 500 μm. Optionally, in any method, microfeature(s), composition, material, and system disclosed herein, each of the plurality of starting layers or each of the plurality of starting layers other than the first layer has a thickness selected from the range of 10 nm to 1000 μm, optionally any thickness therebetween inclusively, optionally selected from the range of 1 μm to 500 μm. Optionally, in any method, microfeature(s), composition, material, and system disclosed herein, the second starting layer and the third starting layer has a thickness selected from the range of 10 nm to 1000 μm, optionally any thickness therebetween inclusively, optionally selected from the range of 1 μm to 500 μm. Optionally, in any method, microfeature(s), composition, material, and system disclosed herein, each starting layer's composition is a metal, metal alloy, metal oxide, dielectric material, glass, one or more allotropes of carbon (such as carbon fiber), ceramic, semiconductor, or any combination of these. Optionally, in any method, microfeature(s), composition, material, and system disclosed herein, each starting layer's composition is a metal, metal alloy, metal oxide, dielectric material, one or more allotropes of carbon (such as carbon fiber), ceramic, semiconductor, or any combination of these. Optionally, in any method, microfeature(s), composition, material, and system disclosed herein, each of the first composition, second composition, and third composition is selected from the group consisting of: iron, an iron containing metal alloy, steel, stainless steel, copper, aluminum, platinum, silver, gold, nickel, zinc, and any combination of these. Optionally, in any method, microfeature(s), composition, material, and system disclosed herein, the first composition is a steel or copper. Optionally, in any method, microfeature(s), composition, material, and system disclosed herein, at least one of the plurality of starting layers is a metallic foil. Optionally, in any method, microfeature(s), composition, material, and system disclosed herein, the topmost starting layer is a metal foil.

Optionally, any method disclosed herein comprises femtosecond laser surface processing (FSLP). Optionally, any method disclosed herein comprises scanning (e.g., rastering) the pulsed laser beam on the multi-layer during the step of irradiating thereby exposing the plurality of locations to the pulsed laser beam. Optionally, scanning (or, rastering) the pulsed laser beam may be accomplished or performed by (1) translating the laser beam and/or adjusting an angle of the laser beam at the layer or surface being irradiated, such as by using one or more mirrors to direct the laser beam, and/or by (2) changing a location of the irradiated the layer or surface relative to a location of the laser beam, such as using a movable/translatable and/or tiltable sample stage. Optionally, in any method disclosed herein, the step of scanning is characterized by a scan speed selected from the range of 0.01 mm/s to 10 m/s, optionally any value or range therebetween inclusively. Optionally, in any method disclosed herein, the pulsed laser beam is characterized by a pulse frequency selected from the range of 1 Hz to 100 MHz, optionally any value or range therebetween inclusively. Optionally, in any method disclosed herein, the pulsed laser beam is characterized by a pulse energy selected from the range of 1 nJ to 30 J, optionally any value or range therebetween inclusively. Optionally, in any method disclosed herein, the pulsed laser beam is characterized by a fluence selected from the range of 0.01 J/cm² to 100 J/cm², optionally any value or range therebetween inclusively. Optionally, in any method disclosed herein, the step of irradiating is characterized by a pulse length selected from the range of 1 fs to 10 ps, optionally selected from the range of 10 ps to 100 ns, optionally selected from the range of 1 fs to 100 ns, or optionally any value or range therebetween inclusively. Optionally, in any method disclosed herein, the step of irradiating is characterized by a spot density selected from the range of 10 to 50,000 spots/mm², optionally 10 to 50,000 spots/cm², optionally any value or range therebetween inclusively, optionally 10 to 50,000 spots/dm², optionally 10 to 50,000 spots/m², optionally 10 to 50,000 spots/m². Optionally, in any method disclosed herein, the step of irradiating is characterized by a spot density selected from the range of 10 to 5,000,000 spots/cm², optionally any value or range therebetween inclusively, such as optionally 10 to 500,000 spots/cm², optionally 100 to 500,000 spots/cm², optionally 1000 to 500,000 spots/cm², optionally 1000 to 300,000 spots/cm², optionally 10,000 to 500,000 spots/cm². Optionally, in any method disclosed herein, the pulsed laser beam is characterized by an average spot size selected from the range of 100 nm to 1 cm, optionally any value or range therebetween inclusively, such as optionally 1 μm to 1000 μm or optionally 1 μm to 1 cm. In some embodiments, parameters of the step of irradiating and of the pulsed beam laser may be controlled independently, including but not limited to, scan speed, pulse energy, fluence, spot size, pulse length, pulse density or pulses-per-area, and pulse frequency, to tune parameters of the microfeatures, including, but not limited to, thickness of one or more microfeature layers, microstructure of one or more microfeature layers, presence or absence and microstructure of the redeposited surface layer, peak-to-valley height, and presence or absence or thickness of an interfacial layer. In some embodiments, some parameters of the pulsed laser beam may be interdependent, such as scan velocity and repletion rate of the pulsed laser beam or pulse energy and beam diameter or spot size. Optionally, in any method disclosed herein, formation of the plurality of microfeatures during the step of irradiating comprises ablation (e.g., “valley ablation”) of portions of the starting multi-layer material that surround each microfeature.

Optionally, any method disclosed herein comprises forming the plurality of starting layers of the multi-layer starting material, the step of forming comprising depositing a starting layer onto another starting layer, bonding a starting layer onto another starting layer, compressing a starting layer onto another starting layer, adhering a starting layer to another starting layer, or any combination of these. Optionally, any method disclosed herein comprises removing all but the first starting layer of the plurality of starting layers after the step of irradiating is complete. Optionally, any method disclosed herein comprises removing or isolating the plurality of microfeatures. Optionally, any method disclosed herein comprises removing at least a portion of the surface redeposited-layer from each microfeature. Optionally, removing at least a portion of the surface redeposited-layer from each microfeature is performed using ultrasonication of the microfeatures. Preferably, the microfeature layers other than the surface redeposited-layer are retained (not removed or separated from the respective microfeature) during the step of removing the at least a portion of the surface redeposited-layer.

Preferably, the first microfeature layer of each microfeature is a portion of the first starting layer and the second microfeature layer of each microfeature is a portion of the second starting layer. Preferably, the third microfeature layer, if present, of each microfeature is a portion of the third starting layer, if present, of the starting material. Preferably, the first microfeature layer, or a majority portion thereof, of each microfeature has the same microstructure as that of the first starting layer. Preferably, the second microfeature layer, or a majority portion thereof, of each microfeature has the same microstructure as that of the second starting layer. Preferably, the third microfeature layer, if present, or a majority portion thereof, of each microfeature has the same microstructure as that of the third starting layer, if present.

Optionally, in any method, microfeature(s), composition, material, and system disclosed herein, the plurality of microfeature layers comprises a same layer sequence as a layer sequence of the plurality of starting layers. A “layer sequence” refers to a relative sequence or order of layers, such as the sequence of a first layer, followed by a second layer, followed by a third layer. Optionally, in any method, microfeature(s), composition, material, and system disclosed herein, the plurality of microfeature layers comprises a third microfeature layer having the third composition; and wherein the second microfeature layer is in between the first microfeature layer and the third microfeature layer. Optionally, in any method, microfeature(s), composition, material, and system disclosed herein, the third microfeature layer is directly adjacent to the second microfeature layer or is separated from the second microfeature layer by an interfacial layer having a thickness less than 10 μm. Optionally, in any method, microfeature(s), composition, material, and system disclosed herein, each microfeature layer, other than a surface-redeposited layer, if present, has a thickness selected from the range of 10 nm to 500 μm, optionally any value or range therebetween inclusively, optionally selected from the range of 1 μm to 500 μm. Optionally, in any method, microfeature(s), composition, material, and system disclosed herein, each microfeature is a mound, peak, or pillar. Optionally, in any method, microfeature(s), composition, material, and system disclosed herein, each microfeature has a peak-to-valley height selected from the range of 1 μm to 500 μm, optionally any value or range therebetween inclusively. Optionally, in any method, microfeature(s), composition, material, and system disclosed herein, the microfeatures are arranged as an array on a substrate, the substrate comprising the first composition. Optionally, the array is periodic or semi-periodic. Optionally, in any method, microfeature(s), composition, material, and system disclosed herein, an interface between any two microfeature layers is compositionally abrupt or comprises an interfacial layer; wherein the interfacial layer has thickness less than 10 μm, optionally less than 5 μm, optionally less than 1 μm, and has an interfacial composition comprising a mixture of a composition of each of the microfeature layers adjacent to the interfacial layer. The interfacial composition, if present between any two microfeature layers, may be formed by melting of the respective two layers at their interface during the step of irradiating. Optionally, in any method, microfeature(s), composition, material, and system disclosed herein, each microfeature comprises a surface redeposited-layer having a redeposited-layer composition; wherein the surface composition comprises oxygen and a composition from a microfeature layer adjacent to the surface redeposited-layer; and wherein the surface redeposited-layer is formed by redeposition of an ablated or vaporized material during the step of irradiating. Optionally, in any method, microfeature(s), composition, material, and system disclosed herein, the surface composition comprises one or more metal oxides. Optionally, in any method, microfeature(s), composition, material, and system disclosed herein, at least a portion of the surface redeposited-layer comprises or is substantially in the form of a plurality of nanoparticles and/or microparticles. Optionally, in any method, microfeature(s), composition, material, and system disclosed herein, the surface redeposited-layer has a thickness less than or equal to 20 μm, optionally less than or equal to 10 μm, optionally less than or equal to 5 μm, optionally less than or equal to 1 μm. Optionally, in any method, microfeature(s), composition, material, and system disclosed herein, each microfeature layer or each microfeature layer other than the surface redeposited-layer is in the form of a polycrystalline film or in the form of that of the corresponding starting layer having the same composition. Optionally, in any method, microfeature(s), composition, material, and system disclosed herein, each of the plurality of microfeatures is adjacent to, contiguous with, or attached to a substrate layer of the multi-layer starting material. Optionally, in any method, microfeature(s), composition, material, and system disclosed herein, the substrate layer has the first composition. Optionally, in any method, microfeature(s), composition, material, and system disclosed herein, the first starting layer, or at least a portion thereof, is the substrate layer.

Optionally, in any method, microfeature(s), composition, material, and system disclosed herein, a region of the starting material comprising the microfeatures is hydrophobic or hydrophilic (e.g., hydrophilic or superhydrophilic) and a region free of the microfeatures is the other of hydrophobic or hydrophilic (e.g., hydrophobic or superhydrophobic). Optionally, any method system disclosed herein comprises removing at least one starting layer (optionally, only the topmost layer) after the step of irradiating is complete; wherein at least one (non-removed) starting layer is remained in the starting material during the step of removing. Optionally, any method system disclosed herein removing at least one starting layer comprises removing a topmost starting layer; wherein the at least one remaining starting layer is free of a re-deposited surface layer in regions free of the microfeatures. Optionally, any method system disclosed herein a surface of a topmost of the at least one remaining starting layer (or region(s) thereof free of microstructures) exposed by the removing at least one starting layer is hydrophobic or hydrophilic, and wherein a region of the starting material comprising the microfeatures is the other of hydrophobic or hydrophilic. Optionally, any method system disclosed herein removing at least one starting layer comprises removing at least a portion of the microfeatures; and wherein remaining one or more starting layers comprise cavities formed by the pulsed laser beam during the step of irradiating. A cavity in a layer may optionally be a cavity/hole/pit partially through a layer or optionally entirely through a layer.

Aspects and embodiments disclosed herein include a method for forming a plurality of microfeatures, the method comprising: irradiating a starting multi-layer material with a pulsed laser beam at a plurality of locations of the multi-layer material; wherein: the starting multi-layer material comprises a plurality of starting layers each layer having a composition different from that of each other starting layer; the plurality of starting layers comprises a first starting layer having a first composition, a second starting layer having a second composition, and a third layer having a third composition; the plurality of microfeatures form in the multi-layer starting material during the step of irradiating; each microfeature comprises a plurality of microfeature layers comprising a first microfeature layer having the first composition, a second microfeature layer having the second composition, and a third microfeature layer comprising the third composition. Optionally, each of the first, second, and third composition is an inorganic material. Preferably, the first microfeature layer of each microfeature is a portion of the first starting layer and the second microfeature layer of each microfeature is a portion of the second starting layer. Preferably, the third microfeature layer, if present, of each microfeature is a portion of the third starting layer, if present, of the starting material. Preferably, the first microfeature layer, or a majority portion thereof, of each microfeature has the same microstructure as that of the first starting layer. Preferably, the second microfeature layer, or a majority portion thereof, of each microfeature has the same microstructure as that of the second starting layer. Preferably, the third microfeature layer, if present, or a majority portion thereof, of each microfeature has the same microstructure as that of the third starting layer, if present.

Aspects and embodiments disclosed herein include a microfeature comprising: three or more microfeature layers, each microfeature layer have a composition different from that of each other microfeature layer; the three or more microfeature layers comprising: a first microfeature layer having a first composition and a second microfeature layer having a second composition; wherein the second microfeature layer is directly adjacent to the first microfeature layer or is separated from the first microfeature layer by an interfacial layer having a thickness less than 10 μm. Optionally, the microfeature further comprises a third microfeature layer having a third composition; wherein the second microfeature layer is in between the first and third microfeature layers; wherein the third microfeature layer is directly adjacent to the second microfeature layer or is separated from the second microfeature layer by an interfacial layer having a thickness less than 10 μm. Optionally, each of the first, second, and third composition, if present, is an inorganic material. Optionally for any microfeature disclosed herein, each of the first, second, and third composition, if present, is a metal, metal alloy, metal oxide, dielectric material, glass, one or more allotropes of carbon (such as carbon fiber), ceramic, semiconductor, or any combination of these. Optionally for any microfeature disclosed herein, each of the first, second, and third composition, if present, is a metal, metal alloy, a metal oxide, or a combination of these. Preferably, the first microfeature layer of each microfeature is a portion of the first starting layer and the second microfeature layer of each microfeature is a portion of the second starting layer. Preferably, the third microfeature layer, if present, of each microfeature is a portion of the third starting layer, if present, of the starting material. Preferably, the first microfeature layer, or a majority portion thereof, of each microfeature has the same microstructure as that of the first starting layer. Preferably, the second microfeature layer, or a majority portion thereof, of each microfeature has the same microstructure as that of the second starting layer. Preferably, the third microfeature layer, if present, or a majority portion thereof, of each microfeature has the same microstructure as that of the third starting layer, if present.

Aspects and embodiments disclosed herein include a microfeature comprising: three or more microfeature layers, each microfeature layer have a composition different from that of each other microfeature layer; the three or more microfeature layers comprising: a first microfeature layer having a first composition; a second microfeature layer having a second composition; wherein the second microfeature layer is directly adjacent to the first microfeature layer or is separated from the first microfeature layer by an interfacial layer having a thickness less than 10 μm; and a third microfeature layer having a third composition; wherein the second microfeature layer is in between the first and third microfeature layers; wherein the third microfeature layer is directly adjacent to the second microfeature layer or is separated from the second microfeature layer by an interfacial layer having a thickness less than 10 μm. Optionally, each of the first, second, and third composition is an inorganic material. Optionally for any microfeature disclosed herein, each of the first, second, and third composition is a metal, metal alloy, a metal oxide, or a combination of these. Preferably, the first microfeature layer of each microfeature is a portion of the first starting layer and the second microfeature layer of each microfeature is a portion of the second starting layer. Preferably, the third microfeature layer, if present, of each microfeature is a portion of the third starting layer, if present, of the starting material. Preferably, the first microfeature layer, or a majority portion thereof, of each microfeature has the same microstructure as that of the first starting layer. Preferably, the second microfeature layer, or a majority portion thereof, of each microfeature has the same microstructure as that of the second starting layer. Preferably, the third microfeature layer, if present, or a majority portion thereof, of each microfeature has the same microstructure as that of the third starting layer, if present.

Aspects and embodiments disclosed herein include a microfeature comprising: three or more microfeature layers, each microfeature layer have a composition different from that of each other microfeature layer; the three or more microfeature layers comprising: a first microfeature layer having a first composition; a second microfeature layer having a second composition; wherein the second microfeature layer is directly adjacent to the first microfeature layer or is separated from the first microfeature layer by an interfacial layer having a thickness less than 10 μm; and a third microfeature layer having a third composition; wherein the second microfeature layer is in between the first and third microfeature layers; wherein the third microfeature layer is directly adjacent to the second microfeature layer or is separated from the second microfeature layer by an interfacial layer having a thickness less than 10 μm; wherein each of the first, second, and third composition is a metal, metal alloy, metal oxide, dielectric material, glass, one or more allotropes of carbon (such as carbon fiber), ceramic, semiconductor, or any combination of these. Preferably, the first microfeature layer of each microfeature is a portion of the first starting layer and the second microfeature layer of each microfeature is a portion of the second starting layer. Preferably, the third microfeature layer, if present, of each microfeature is a portion of the third starting layer, if present, of the starting material. Preferably, the first microfeature layer, or a majority portion thereof, of each microfeature has the same microstructure as that of the first starting layer. Preferably, the second microfeature layer, or a majority portion thereof, of each microfeature has the same microstructure as that of the second starting layer. Preferably, the third microfeature layer, if present, or a majority portion thereof, of each microfeature has the same microstructure as that of the third starting layer, if present.

Optionally, any microfeature comprises a surface redeposited-layer having a redeposited-layer composition; wherein the redeposited-layer composition comprises an oxidized composition from a microfeature layer near the surface redeposited-layer; and wherein at least a portion of the surface redeposited-layer is in the form of a plurality of nanoparticles and/or microparticles. Optionally for any microfeature, the surface redeposited-layer has a thickness less than or equal to 20 μm, optionally less than or equal to 10 μm, optionally less than or equal to 5 μm, optionally less than or equal to 1 μm.

Optionally for any microfeature, each microfeature layer or each microfeature layer other than the surface redeposited-layer, if present, is in the form of a polycrystalline film. Optionally for any microfeature, each microfeature layer other than the surface redeposited-layer, if present, has a thickness selected from the range of 10 nm to 500 μm, optionally any thickness therebetween inclusively, optionally selected from the range of 1 μm to 500 μm. Optionally for any microfeature, each microfeature is a mound or pillar. Optionally for any microfeature, each microfeature has a peak-to-valley height selected from the range of 1 μm to 500 μm, optionally any thickness therebetween inclusively. Optionally for any microfeature, an interface between any two microfeature layers is compositionally abrupt or comprises an interfacial layer; wherein the interfacial layer has thickness less than 10 μm and has an interfacial composition comprising a mixture of a composition of each of the microfeature layers adjacent to the interfacial layer.

Optionally, any microfeature is attached to, bound to, or otherwise on a substrate. Optionally, any microfeature is attached to, bound to, connected to, or associated with a substrate. Optionally, any microfeature is free of a substrate. Optionally, any microfeature is not attached to, bound to, connected to, or associated with a substrate. Optionally, the substrate has the first composition and wherein the first microfeature layer is contiguous or compositionally continuous with respect to the substrate. Optionally, the first starting layer, or at least a portion thereof, is the substrate layer.

Aspects and embodiments disclosed herein include a plurality of microfeatures, each microfeature being a microfeature according to any one or any combination of embodiments of a microfeature disclosed herein. Optionally, the plurality of microfeatures are arranged as an array on a substrate or being in the form of a powder free of a substrate. Optionally, the first starting layer, or at least a portion thereof, is the substrate layer. Preferably, the first microfeature layer of each microfeature is a portion of the first starting layer and the second microfeature layer of each microfeature is a portion of the second starting layer. Preferably, the third microfeature layer, if present, of each microfeature is a portion of the third starting layer, if present, of the starting material. Preferably, the first microfeature layer, or a majority portion thereof, of each microfeature has the same microstructure as that of the first starting layer. Preferably, the second microfeature layer, or a majority portion thereof, of each microfeature has the same microstructure as that of the second starting layer. Preferably, the third microfeature layer, if present, or a majority portion thereof, of each microfeature has the same microstructure as that of the third starting layer, if present.

Aspects and embodiments disclosed herein include a material comprising a plurality of microfeatures, each microfeature being a microfeature according to any one or any combination of embodiments of a microfeature disclosed herein, the composition further comprising: one or more first regions being free of the microfeatures, wherein a surface of the one or more first regions is hydrophobic or hydrophilic; and one or more second regions comprising the microfeatures, wherein a surface of the one or more second regions is the other of hydrophobic or hydrophilic. Optionally, the surface of the one or more second regions is hydrophilic or superhydrophilic and the surface of the one or more first regions is hydrophobic or superhydrophobic.

Aspects and embodiments disclosed herein include a method for forming a plurality of cavities, the method comprising: irradiating a starting multi-layer material with a pulsed laser beam at a plurality of locations of the multi-layer material; wherein: the starting multi-layer material comprises a plurality of starting layers comprising a first starting layer having a first composition and a second starting layer adjacent to the first starting layer and having a second composition different than the first composition; the step of irradiating comprises forming a plurality of cavities in at least one starting layer via ablation of the at least one starting layer by the pulsed laser beam. Optionally, the plurality of cavities are formed through the first starting layer and at least partially through the second starting layer. Optionally, the method comprises removing at least one starting layer after the step of irradiating is complete; wherein at least one starting layer having the plurality of cavities is remained in the starting material. Optionally, the step of irradiating comprises forming a plurality of microfeatures in at least the second starting layer.

Also disclosed herein is a microfeature and plurality of microfeatures formed by any method disclosed herein or any embodiment(s) of a method disclosed herein. Also disclosed herein are systems capable of performing or configured for performing any method disclosed herein or any embodiment(s) of a method disclosed herein. For example, systems disclosed herein include femtosecond laser systems, which may include appropriate power source(s), light source(s), optics, etc., as would be known by one of skill in the relevant arts, including fields of laser processing and optics. Also disclosed herein are methods for forming any microfeature and any plurality of microfeatures disclosed herein.

Generally, but not necessarily, when describing a “starting layer” (e.g., a first starting layer, a second starting layer, or a third starting layer) of a multi-layer starting material, the higher the reference number (e.g., first, second, third, etc.) of a described starting layer the closer that described starting layer is to the laser beam during the step of irradiating. For example, in a multi-layer starting material having a first starting layer, a second starting layer, and a third starting layer, the third starting layer may be the topmost layer and thereby closest to the pulsed laser beam during the step of irradiating. Generally, but not necessarily, when describing a “microfeature layer” (e.g., a first microfeature layer, a second microfeature layer, or a third microfeature layer) of a microfeature, the higher the reference number (e.g., first, second, third, etc.) of a described microfeature layer the closer that described microfeature layer is to the laser beam during the step of irradiating. For example, in a microfeature having a first microfeature layer, a second microfeature layer, and a third microfeature layer, the third starting layer may be the topmost layer of these three microfeature layers.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: Schematic of an example of a triple-layer material that is laser processed with a femtosecond laser beam. An illustration of a portion of an exemplary method and system, according to certain embodiments herein, for forming microfeatures. The terms “Material #1”, “Material #2”, and “Material #3” refer to exemplary starting layer of a multi-layer starting material.

FIG. 2: SEM image taken at 45° of 3ML-FLSP structures on the multi-material, multi-layer combination of aluminum on copper on stainless steel.

FIGS. 3A-3D: Cross-sections of a single structure from raster scans on different multi-material, multi-layer combinations. FIG. 3A: Aluminum on copper on stainless steel. FIG. 3B: Copper on aluminum on stainless steel. FIG. 3C: Reincorporated material that redeposited/resolidified on the peak of aluminum on stainless steel. FIG. 3D: Two low carbon steel layers on top on aluminum.

FIGS. 4A-4I: Initiating the growth of structures on copper. FIGS. 4A-4C: SEM images taken at 45° of copper structured without a stainless steel foil. FIGS. 4D-4F: SEM images of multi-material, multi-layer combination on stainless steel on copper [SS on Cu]. FIGS. 4G-4I: Focused ion beam images of a cross section of an individual structure from the [SS on Cu] raster patterns (the red box indicated the structure that was cross sectioned). FIGS. 4A-4F were all imaged with the same magnification in the SEM.

FIGS. 5A-5B: SEM images of structures produced with and without multi-material, multi-layer combinations at identical laser processing parameters on (FIG. 5A) glass only and (FIG. 5B) stainless steel on glass.

FIGS. 6A-6B: SEM image and EDS map of a cross section of the multi-material, multi-layer combination of silver on aluminum. FIG. 6A: SEM image. FIG. 6B: EDS map. The EDS map is colored according to where the aluminum platinum and silver are incorporated on the cross sectioned structure. Platinum is from the platinum protective layer that is deposited on the structure to protect it during ion beam milling.

FIGS. 7A-7C: SEM images and EDS linescan of the resolidified material at the peak of the cross sectioned structure on the multi-material, multi-layer combination of aluminum on copper on stainless steel. FIG. 7A: SEM image. FIG. 7B: High magnification SEM image at the peak of the structure with the location of an EDS linescan. FIG. 7C: EDS linescan showing the mixture of all three materials at the peak of the structure.

FIGS. 8A-8B: SEM images of areas processed with multi-layer laser processing. Areas between the red dashed lines were processed with a laser beam.

FIG. 8A: Laser processed without using a multi-layer material. FIG. 8B: Laser processed while using a multi-layer material. Areas surrounding the raster scanned areas were not covered in a layer of redeposited particles after removing the excess foil material from the surface.

FIG. 9: An illustration of a portion of an exemplary method and system, according to certain embodiments herein, for forming microfeatures. The terms “Foil” and “Sample” refer to exemplary starting layers of a multi-layer starting material.

FIGS. 10A-10D: Multi-material, multi-layered FLSP structures. From bottom to top material (FIG. 10A) SS304_Cu_Al, (FIG. 10B) SS304_Al_Cu, (FIG. 10C) SS304_SS304_SS304, and (FIG. 10D) single material SS304.

FIGS. 11A-11B: SEM images taken at 45° of 3ML-FLSP on SS304_Cu_Al. FIG. 11A: Morphology of the mound that was cross-sectioned (red arrow indicates the cross-sectioned mound). FIG. 11B: Cross-section of mound.

FIG. 12: SEM of the cross section of a 3ML-FLSP structure with arrows indicating the location and direction of EDS linescans of FIGS. 13A-13C.

FIGS. 13A-13C: EDS scans associated with the SEM of the cross section of the 3ML-FLSP structure shown in FIG. 12.

FIG. 14A: SEM image of the peak of the 3ML-FLSP structure and (FIGS. 14B-14C) associated EDS linescans.

FIG. 15A: Low and (FIG. 15B) High magnification ion beam images of a cross section of 3ML-FLSP SS304_Cu_Al. The red dashed ellipse indicates the brighter edges of the peak and the blue circle indicated the central region of the peak.

FIGS. 16A-16B: 3ML-FLSP of SS304_Cu_Al (FIG. 16A) surface and (FIG. 16B) subsurface morphology.

FIG. 17: Location of EDS linescans on 3ML-FLSP of SS304_Cu_Al. EDS data is displayed in Error! Reference source not found. 18A-18C.

FIGS. 18A-18C: EDS linescan data related to 3ML-FLSP structure of FIG. 17.

FIGS. 19A-19B: Ion beam images of 3ML-FLSP on SS304_Cu_Al (FIG. 19A) low and (FIG. 19B) high magnification.

FIGS. 20A-20B: 3ML-FLSP structures on SS304 Al_Cu (FIG. 20A) surface and (FIG. 20B) subsurface morphology.

FIG. 21A: Low and (FIG. 21B) high magnification cross sections of 3ML-FLSP on SS304_Al_Cu with EDS linescan location and directions. EDS linescan data is depicted in Error! Reference source not found. 22A-22C.

FIGS. 22A-22C: EDS linescan data for 3ML-FLSP on SS304_Al_Cu. Scan location and directions are depicted in FIGS. 21A-21B.

FIGS. 23A-23F: EDS map of 3ML-FLSP on SS304_Al_Cu. Each cell corresponds to a different element. FIG. 23A: SEM image. FIG. 23B: EDS mapping overview. FIG. 23C: Oxygen. FIG. 23D: Iron. FIG. 23E: Copper. FIG. 23F: Aluminum.

FIGS. 24A-24B: Ion beam images of 3ML-FLSP on SS304_Al_Cu (FIG. 24A) Cu peak (FIG. 24B) Al middle layer.

FIG. 25: An illustration of a portion of an exemplary method and system, according to certain embodiments herein, for forming microfeatures. The terms “Gasket material” and “Sample” refer to exemplary starting layers of a multi-layer starting material. The gasket material or first layer is, for example, SS304 with a thickness of 0.002″ or ˜50 μm. The multiple layers of the multi-layer starting material may be held together by a compression, such as using a clamp as illustrated, during irradiation by a pulsed laser.

FIG. 26: Multi-material FLSP: SEM images of the sample layer after removing the gasket material from the sample surface (SS304 on SS304). At lower fluences, after removing the gasket material, only the cavities or pits between the FLSP structures remained on the sample surface (left SEM panel). As fluence increases, melting causes the peaks created on the gasket to adhere to the base sample (see right two SEM panels). Not all of the structure peaks were removed when the gasket was removed at this specific fluence. As illustrated by these results, embodiments herein include drilling of arrays of holes in a material using a pulsed laser beam.

FIG. 27: Multi-material FLSP: SEM images of the sample after removing the gasket material from the sample surface (SS304 on SS304).

FIG. 28: An illustration of a portion of an exemplary method and system, according to certain embodiments herein, for forming microfeatures. The terms “Gasket material” and “Sample” refer to exemplary starting layers of a multi-layer starting material. The sample or first layer (also substrate layer in this case) is, for example, stainless steel (SS304). The Gasket material #2, or second layer, is, for example, copper and may be 0.001″ or 25 μm thick, for example. The Gasket material #1, or third layer, is, for example, aluminum and may be 0.001″ or 25 μm thick, for example.

FIG. 29: SEM images of microfeatures comprising layers of aluminum on copper on SS304, according to embodiments herein, formed by certain embodiments of methods disclosed herein.

FIG. 30: SEM images of microfeatures comprising layers of aluminum on copper on SS304, according to embodiments herein, formed by certain embodiments of methods disclosed herein.

FIG. 31: An illustration of a portion of an exemplary method and system, according to certain embodiments herein, for wettability patterning.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The term “microfeature” refers to a feature or object having at least one characteristic physical dimension that is selected from the range of 1 μm to 1000 μm. The at least one characteristic physical dimension of the microfeature may be, but is not limited to, a height, a width, a diameter, a full-width-at-half-maximum (FWHM) of a curve or function that approximates the shape of the feature, an amplitude (or, height) of a curve or function that approximates the shape of the feature, a peak-to-valley height, etc. The feature may be a microstructural feature or object, such as a mound or pillar. The feature is optionally, but no necessarily, rising from, tethered to, attached to, compositionally continuous with, connected to, and/or otherwise associated with a surface, such as a surface of a layer, film, or material. “Mounds” described and characterized throughout herein are exemplary microfeatures, according to embodiments herein. The microfeatures described herein are multi-layered and multi-material structures, which may also be referred to herein as self-organized structures and surface structures. The microfeatures may be hierarchical, comprising both microscale and nanoscale features. For example, a re-deposited surface layer, which often comprises a mixture of the composition of a plurality of the starting layers, may have nanoscale features such as nanoparticles, in addition to microparticles. The combination of micro- and nano-scale features may provide enhanced properties of these surfaces, such as hydrophilicity.

The term “peak-to-valley height” refers to a characteristic physical dimension of a microfeature corresponding to a height of the microfeature between its peak and the lowest point nearby or adjacent to the microfeature, such as the lowest point of a region that may be described as a valley nearest to the microfeature. The microfeature's peak generally refers to the topmost point of the microfeature, a point farthest from a characteristic geometric plane or axis of a layer or surface from which the microfeature rises, or point farthest from or opposite of a base of the microfeature, or a point that corresponds to a peak of a curve or function that approximates the shape of the microfeature. Optionally, but not necessarily, the valley of the peak-to-valley measure may correspond to a lowest point or baseline of a curve or function that approximates the shape of the microfeature. Optionally, but not necessarily, the valley of the peak-to-valley measure may correspond to a lowest point between the microfeature being measure/characterized a nearest microfeature, or an average of the lowest points or positions between the microfeature being measure/characterized its nearest neighbor microfeatures. Measuring or determining the peak-to-valley height may include A laser scanning confocal microscope may be used to measure or determine the peak-to-valley height. The laser scanning confocal microscope creates a 3D surface topological map that can then be analyzed to get geometric data for the structures. Optionally, if a microfeature is titled with respect to its respective substrate layer, such as the first starting layer, (or, has a longitudinal axis not normal or perpendicular to a characteristic plane of its substrate layer) then either the peak-to-valley along the microfeature's tilted or longitudinal axis or along an axis perpendicular to its substrate layer may be used to measure the peak-to-valley height. Additional descriptions and information pertaining to determining the peak-to-valley height may be found in A. Tsubaki, et al. (“Multi-material, multi-layer femtosecond laser surface processing”, in Proc. SPIE Vol. 11674, Laser-based Micro- and Nanoprocessing XV, Mar. 10, 2021, doi 10.1117/12.2582756), which is incorporated herein by reference in its entirety.

As used herein, phrase a/the “composition is X”, such as in “the composition is X” or “the first composition is X,” where X is a material, is a characterization of the composition as being a composition corresponding to that of material X. For example, if a first composition is a metal, then the composition is that of or corresponding to a metal, such that a material or layer having the first composition has or comprises a metal composition, or, in other words, has a composition that may be characterized as a metal. For example, an aluminum layer or film has a composition that is a metal (or, in other words, has a metal composition), the metal being aluminum, in this example. For example, a steel layer or film has a composition that is a metal alloy (or, in other words, has a metal alloy composition), the metal alloy being a steel. One of skill in the art of material science will recognize that a certain variety and range of compositions may be referred to steels.

Any two objects, such as microfeatures, materials, regions, or layers, characterized as “compositionally continuous” have identical or substantially identical compositions and each of the two objects has a portion thereof that is directly contiguous with a portion of the other object and free (between the respective portions) of an intervening or separating material having a different composition (such as any solid, liquid, or gaseous material, such as air) from that of the two objects being thus characterized.

An interface between any objects, such as any to microfeature layers, that is characterized as “compositionally abrupt” is one where the interface between the two objects is immediate/abrupt and is free of an intervening or separating material or layer between the two objects. A compositionally abrupt interface between any two objects is preferably free of a mixed composition having a mixture of the compositions of each of the two objects.

The term “contiguous” refers to a characterization of two or more objects, such as microfeatures, materials, regions, or layers, such that at least one object of the two or more contiguous objects has at least one boundary, surface, region, or any portion touching or in physical contact with at least one boundary, surface, region, or any portion of at least one other object of the two or more contiguous objects. For example, a microfeature is contiguous with a substrate layer if at least one boundary, surface, region, or any portion of the microfeature is touching or is in physical contact with at least one boundary, surface, region, or any portion of the substrate layer. For example, a plurality or array of microfeatures is contiguous with a substrate layer if at least one microfeature (of said plurality or array) has a boundary, surface, region, or any portion of the microfeature touching or in physical contact with at least one boundary, surface, region, or any portion of the substrate layer. As used herein, the term “directly adjacent” is intended to be synonymous with the term “contiguous.” As used herein, two objects or two layers characterized as “adjacent to”, but not necessarily “directly adjacent to”, may be contiguous or may be separated by an intervening object or layer, such as an interfacial layer. In preferable embodiments, where any one layer is characterized as adjacent to any other layer, the one layer is either contiguous with (or, directly adjacent to) the other layer or the one layer is separated from the other layer by an intervening layer comprising one or more interfacial layers, the intervening layer having a total thickness of less than or equal to 20 μm, optionally less than or equal to 10 μm, optionally less than or equal to 5 μm, optionally less than or equal to 1 μm.

The term “metal element” refers to a metal element of the periodic table of elements. Optionally, the term “metal element” includes elements that are metalloids. Metalloids elements include B, Si, Ge, As, Sb, and Te. Optionally, metalloid elements include B, Si, Ge, As, Sb, Te, Po, At, and Se. The term “metal” is intended to be consistent with the term as known in the field of materials science, and generally refers to a material having a composition comprising one or more metal elements and which when/if freshly prepared, polished, or fractured, in isolated form, shows a lustrous appearance, and conducts electricity and heat relatively well. As used herein, a metal may be metal alloy, such as, but not limited to, any steel, such any stainless steels. As would be recognized by one skilled in the art, including the field of material science, a metal alloy is a metal whose composition comprises two or more metal elements.

As would be recognized by one skilled in the relevant arts, particularly in the fields of laser technologies or laser ablation technologies, a “pulsed laser beam” refers to a laser beam of a pulsed laser, or laser beam having pulses of laser irradiation, any two pulses being separated by a period of zero or near-zero intensity of the laser light, characterized by a pulse frequency.

Generally, a layer refers a configuration, structure, or geometry that may be characterized or described generally by a characteristic geometric plane (or, two dimensional geometric surface) or a two-dimensional surface and a thickness (or average thickness) of the characteristic geometric plane or the two-dimensional surface along an axis normal or perpendicular to said characteristic geometric plane or two-dimensional surface. A thin film, as the term would be known by one of skill in the field of materials science, is an example of a layer. Optionally, a layer may be conformal with a respective substrate surface or layer. Optionally, a layer may be non-conformal with a respective substrate surface or layer.

The term “spot size” is intended to be consistent with the term of art, particularly in the fields of optics, lasers, and laser processing of materials, and generally refers to a diameter of the laser beam at a point of first impinging upon or first intersecting with a material or object, such as a layer or a surface, or a portion thereof. A laser beam may be characterized by an average spot size.

The term “spot density” refers to a number of discrete locations irradiated by a pulsed laser beam per area of a material, surface, layer, or object being irradiated.

As used herein, the term “microstructure” is intended to have the same meaning as the same term in the art of material science, and generally refers to characteristics of a material (or, layer, film, or object thereof) including, but not limited to, average size of grains or crystallites, size distribution of grains or crystallites, orientation (e.g., random, textured, etc.) of grain or crystallites, and where the material is single crystalline, polycrystalline, or amorphous.

Various potentially useful aspects, embodiments, definitions, aspects, measurement techniques, mechanisms, theories, and/or background information may be found in the following publications, each of which is incorporated herein in its entirety, to the extent not inconsistent herewith: (1) E. Peng, et al. “Micro/nanostructures formation by femtosecond laser surface processing on amorphous and polycrystalline Ni₆₀Nb₄₀”, Applied Surface Science, Volume 396, 28 Feb. 2017, Pages 1170-1176; (2) E. Peng, et al., “Growth mechanisms of multiscale, mound-like surface structures on titanium by femtosecond laser processing,” Journal of Applied Physics 122, 133108 (2017); doi 10.1063/1.4990709; (3) E. Peng, et al., “Formation of Mound-Like Multiscale Surface Structures on Titanium by Femtosecond Laser Processing,” University of Nebraska-Lincoln Spring 2017 Research Fair, Graduate Student Poster Session, Apr. 5, 2017; (4) C. A. Zuhlke, et al. (“Superhydrophobic metallic surfaces functionalized via femtosecond laser surface processing for long term air film retention when submerged in liquid”, Proc. SPIE 9351, Laser-based Micro- and Nanoprocessing IX, 93510J (12 Mar. 2015), doi:10.1117/12.2079164); and (5) G. Beard, et al. (“Embedding Silver into Aluminum Surfaces Using Femtosecond Laser Surface Processing,” Nebraska Academy of Sciences Annual Meeting, virtual, Apr. 23, 2021). For example, some compositions of layers and microfeatures as well as process parameters, such as characteristics of the pulsed laser beam, described in the aforementioned publications may be useful optional embodiments herein, and are hereby incorporated as such.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

The term “and/or” is used herein, in the description and in the claims, to refer to a single element alone or any combination of elements from the list in which the term and/or appears. In other words, a listing of two or more elements having the term “and/or” is intended to cover embodiments having any of the individual elements alone or having any combination of the listed elements. For example, the phrase “element A and/or element B” is intended to cover embodiments having element A alone, having element B alone, or having both elements A and B taken together. For example, the phrase “element A, element B, and/or element C” is intended to cover embodiments having element A alone, having element B alone, having element C alone, having elements A and B taken together, having elements A and C taken together, having elements B and C taken together, or having elements A, B, and C taken together.

The term “±” refers to an inclusive range of values, such that “X±Y,” wherein each of X and Y is independently a number, refers to an inclusive range of values selected from the range of X−Y to X+Y.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

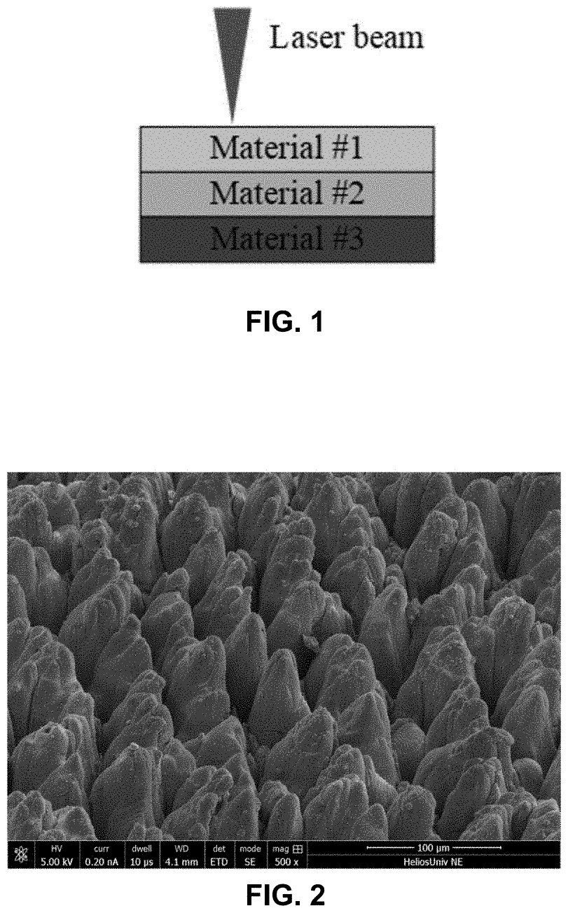

This present embodiments involve novel processes for femtosecond laser surface processing (FLSP) of samples made up of multiple layers of different materials. Thin foils (e.g., <100 μm thick) of different materials are adhered to the surface of a sample which is femtosecond laser processed as depicted in the schematic of FIG. 1. The multi-material, multi-layer surfaces may be created by deposition of 1-100 um layers or by bonding foils together (e.g. laser bonding, diffusion bonding, etc.). It should be appreciated that this process is applicable for any number of layers of material. The number of layers and the thickness of the layers is dependent on the size of the structures created with specific laser parameters (e.g. laser energy per area, number of laser pulses per area, spot diameter, etc.). In an embodiment, a laser beam, e.g., a femtosecond laser beam, is raster scanned across the sample surface to produce self-organized, micro/nanostructures as depicted in the SEM image of FIG. 2. Raster scanning can be accomplished by translating the multi-layered sample on XYZ translation stages or by using a galvo-scanning laser head.

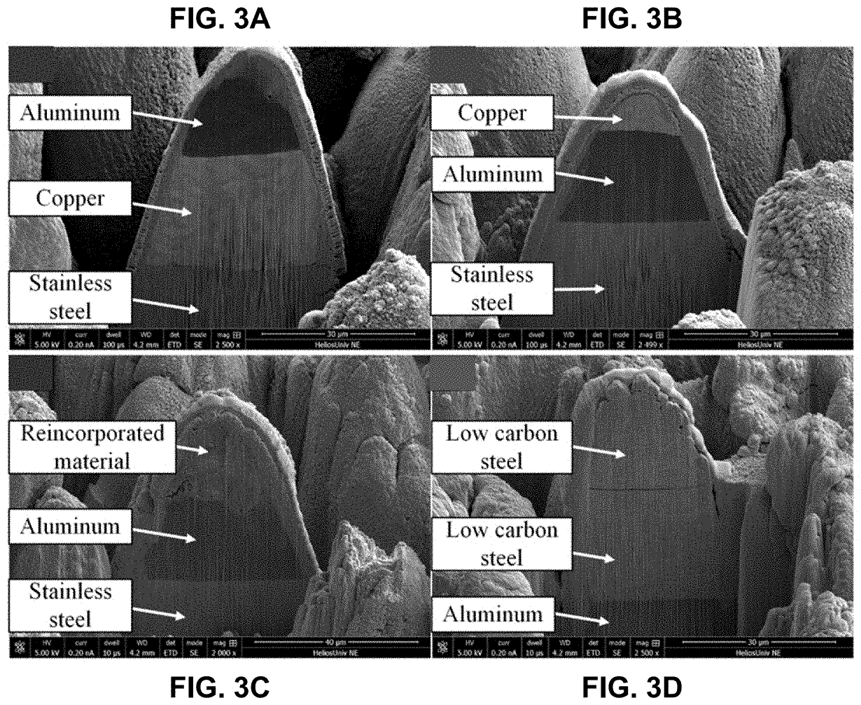

Typically, during the process of FLSP, the surface structures in the SEM images of FIG. 2 are composed out of a single material, but by introducing multi-material, multi-layered samples one can advantageously produce structures which are composed of material from each layer that are incorporated into each individual self-organized structure. An example of four cross sectioned multi-material, multi-layer femtosecond laser processed structures created out of different material combinations is shown in FIGS. 3A-3D.

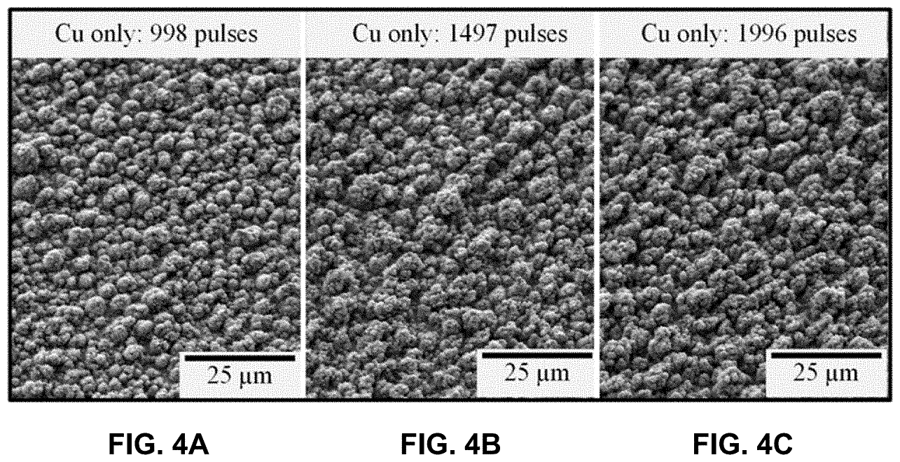

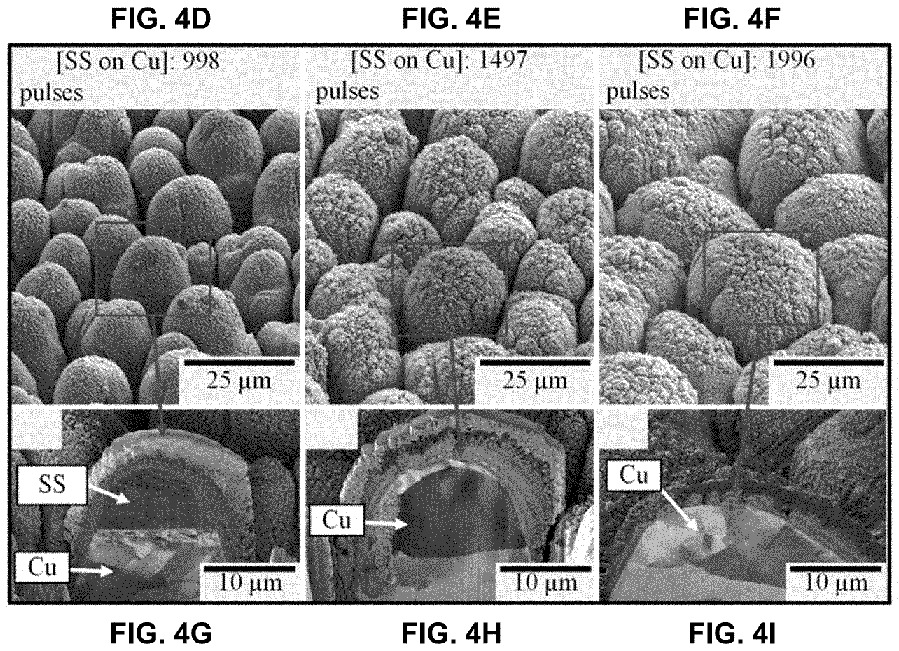

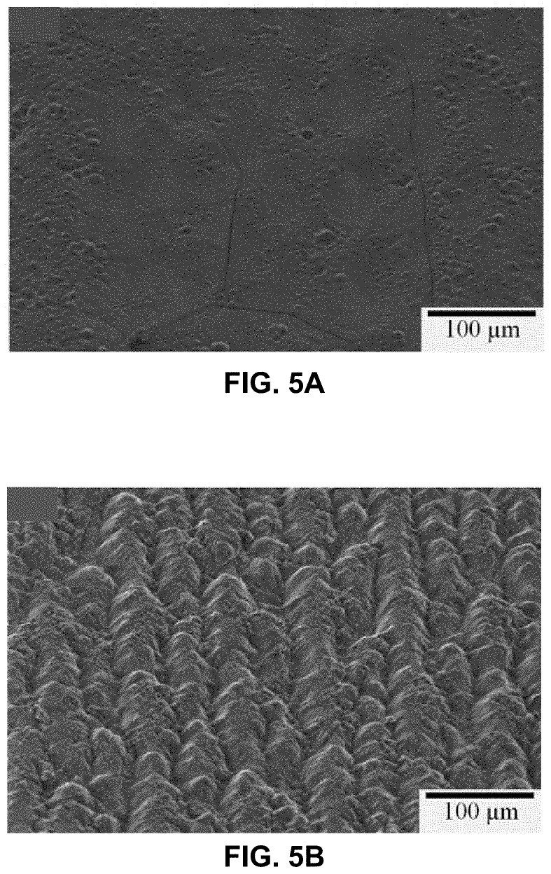

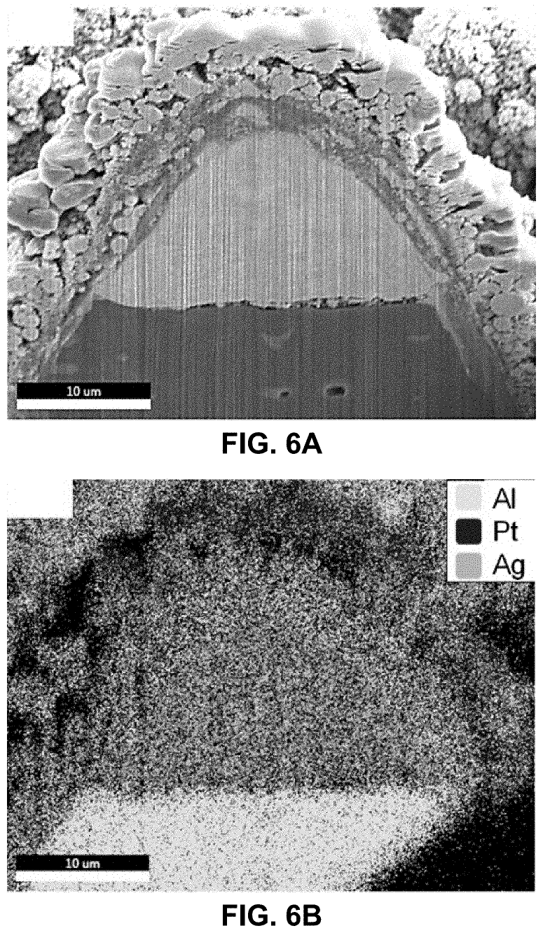

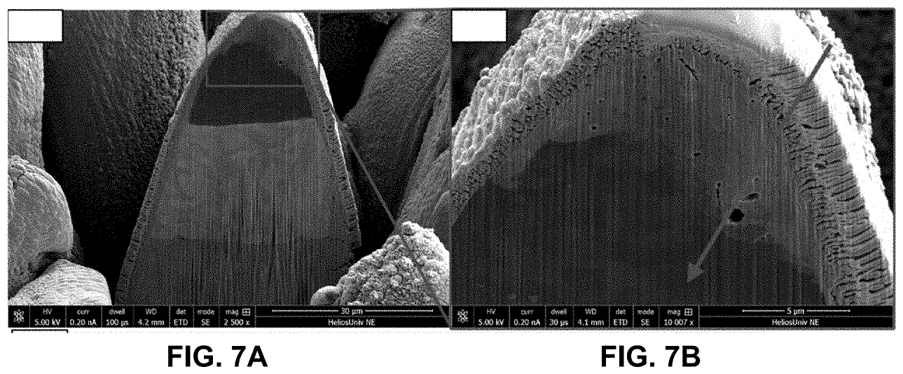

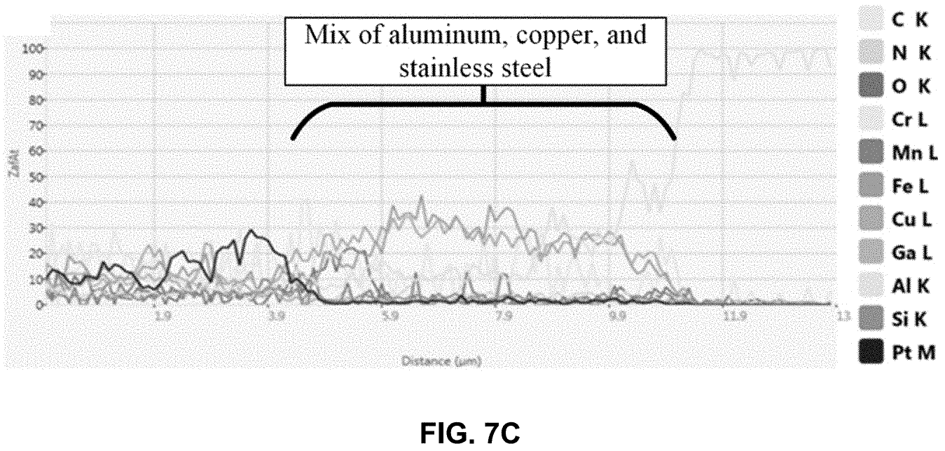

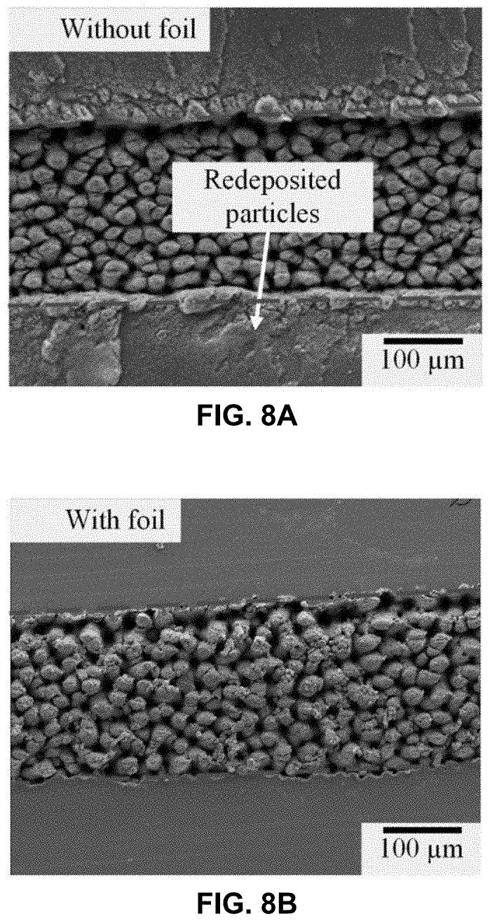

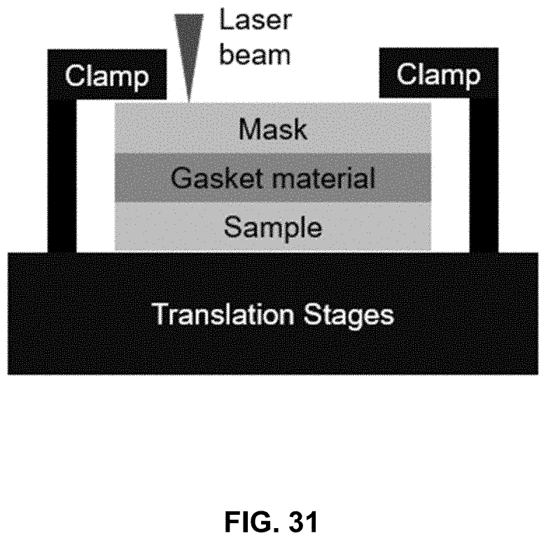

These unique surface structures have a range of potential applications. For example, a method embodiment may be used to produce FLSP structures on materials that otherwise could not be structured with FLSP (e.g., it is easy to produce FLSP structures on stainless steel but not on copper so one can place stainless steel on top of copper to initiate the growth of these structures on copper (see FIGS. 4A-4I)). Copper can form structures without stainless steel, however, it requires a significant increase in energy compared to the energy requirements to use the multi-material, multi-layered approach. Initiating the growth of FLSP structures can also be extended to any material (e.g. glass) (See FIGS. 5A-5B). Another application is the creation of anti-microbial surfaces (e.g., silver is expensive and anti-microbial but by utilizing multiple layers of different materials, it is possible to incorporate silver for anti-microbial applications but with a different underlying substrate for structural integrity and lower cost as shown in the SEM image and energy dispersive x-ray spectroscopy map (EDS) of a cross sectioned structure in FIGS. 6A-6B). Another application is the production of a mixture of material from each layer (e.g., the redeposited/resolidified layers of the EDS scans in FIGS. 7A-7C, which depict a mixture at the peak of the structure that is composed of copper, aluminum, and stainless steel). Another application is the increased emissivity of FLSP surfaces (FLSP stainless steel has an emissivity of 0.737 but the addition of a layer of a 50 μm thick foil of aluminum on SS304 increased the emissivity to 0.899). Another application is the reduction of nanoparticles that deposit surrounding areas processed with the laser beam. During laser processing, nanoparticles redeposit on the areas surrounding the raster scanned region. When foils are used to create the multi-layered surface structures, the excess foil material that is not processed by the laser beam can be removed from the surface and the underlying, unprocessed areas are free from redeposited material as shown in FIGS. 8A-8B. The foil material creates a barrier that prevents unwanted particles from redepositing on the surface. The example of FIG. 8 provides an example of embodiments of methods and compositions disclosed herein in which it is contemplated to form patterned laser processed regions (e.g., with microfeatures) and regions that are non-laser processed areas and are free of laser generated debris and particles. This has applications in, for example, creating surfaces with patterned areas with wettability contrast, like superhydrophilic channels in a hydrophobic/superhydrophobic surface. These patterned surfaces can be used in microfluidic applications and to enhance condensation-based heat transfer. For example, FIG. 31 shows an exemplary method and starting material for FLSP wettability patterning. The mask layer (an exemplary third starting layer, in an embodiment) may be be cut into the desired pattern for the laser processed surface and the foil (an exemplary second starting layer, in an embodiment) serves as a gasket to eliminate the contamination (e.g., re-deposited surface layer or micro/nanoparticles redeposited during irradiation).

Further, multi-material, multi-layer femtosecond laser processing provides insight to understand the fundamentals of FLSP (i.e., track how each material redistributes itself on the structure after FLSP to determine the structure formation mechanisms).

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The invention can be further understood by the following non-limiting examples.

### Example 1: Methods for the Fabrication of Durable Omniphobic and Omniphilic Metallic Surfaces

Overview of the Example: Embodiments in this Example relate to creating multi-layered, multi-material structures, also referred to herein as “microfeatures.” Three layers of different metals were clamped together during laser processing. FLSP structures were cross sectioned to reveal that the three metals did not mix but were produced primarily by preferential valley ablation. Initial studies indicate that the top material influences the growth and overall height of FLSP structures. This is the first time any researcher has produced FLSP structures out of layered materials.

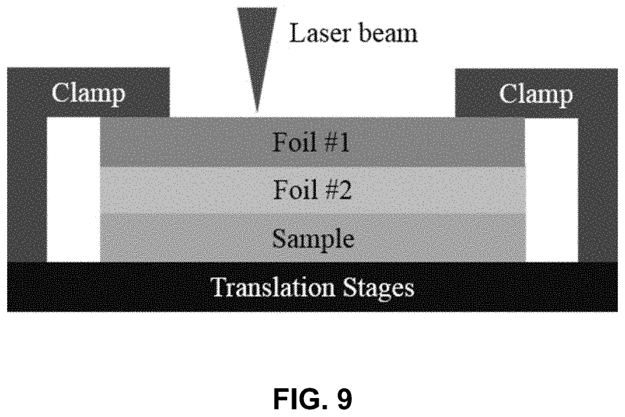

Multi-material, multi-layered FLSP structures: Three materials were clamped together during laser processing as depicted in the schematic of FIG. 9. A 1.16 mm thick SS304 sample was overlaid with 25.4 μm thick interchangeable metal foils. Foil materials include SS304, Cu110, and aluminum.

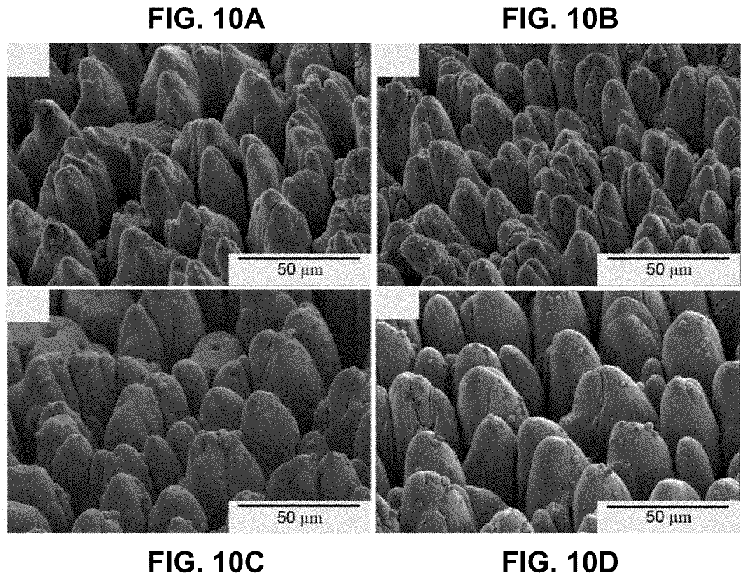

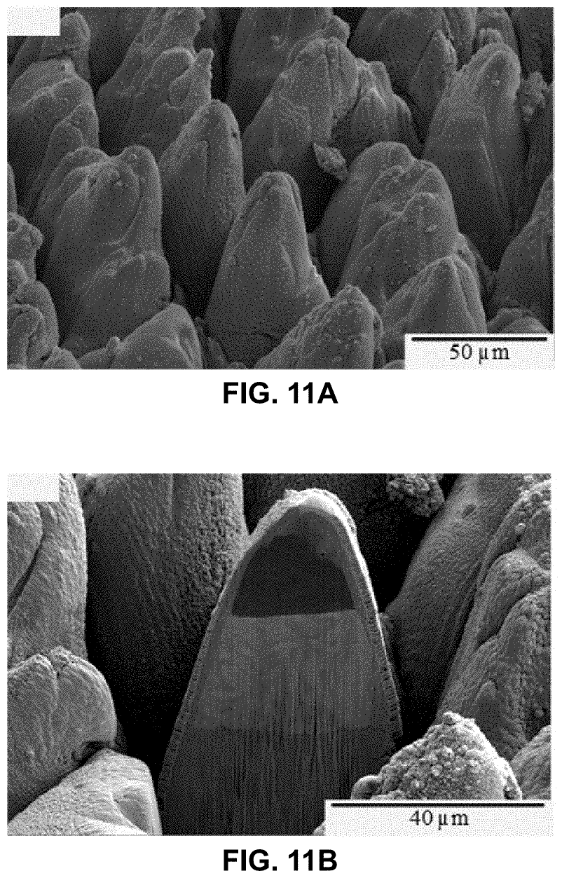

Three Multi-Material, Multi-Layer (3ML) combinations were produced at 2.81 J/cm² and a pulse count of 1540. An additional sample composed of only SS304 without any foil combinations was produced for morphological comparison. Laser processing and physical parameters are tabulated in Error! Reference source not found. and SEM images taken at 45° portray the surface morphology in FIGS. 10A-10D. Fluence and pulse count were calculated according to the laser spot size at the surface of the topmost material. The SS304 without any foils was raised 50.4 μm to compensate for the thickness of the foils and for the distance above the original surface measurement. The naming convention starts with the material at the bottom followed by the middle than the top layer of material (i.e. Bottom_Middle_Top). 3ML-FLSP structures on SS304_SS304_SS304 were 10.5 μm taller than structures produced on SS304 only. SS304_Cu_Al and SS304_Al_Cu structures statistically had the same peak-to-valley height and both were nearly 50 μm taller than SS304 only. Some of the areas of the 3ML-FLSP rasters in FIGS. 2A and 2C lack structure peaks. This was due to the peaks being ablated from the sample during FLSP or post-FLSP when the foils were removed from the sample surface.

TABLE 1
Laser processing and physical
parameters of FLSP structures.

| | | | | Distance |
|---|---|---|---|---|
| | | | | above |
| | | | Peak-to- | original |
| | | Pulse | Valley, | surface |
| Material | Fluence | Count | R_{z} [μm] | [μm] |
| SS304_Cu_Al | 2.81 | 1540 | 120.1 ± 11.4 | 49.5 |
| SS304_Al_Cu | 2.81 | 1540 | 117.8 ± 7.5 | 38.1 |
| SS304_SS304_SS304 | 2.81 | 1540 | 82.0 ± 6.5 | 25.0 |
| SS304 | 2.81 | 1540 | 71.5 ± 3.4 | 31.6 |

Analysis of 3ML-FLSP Structures on SS304_Copper_Aluminum: The mounds from 3ML-FLSP on SS304_Copper_Aluminum (SS304_Cu_Al) were cross-sectioned and characterized using EDS. The average composition of the surface of 6 different mounds is presented in Error! Reference source not found. The EDS surface scans indicated that the SS304_Cu_Al mounds have similar composition due to the low standard deviation associated with each element. Carbon and nitrogen was incorporated due to contamination due to exposure to the atmosphere.

Contributions of iron, copper, and aluminum indicate that all three metals were incorporated in the surface structures. High oxygen content suggested an oxidized nanoparticle layer which is typically associated with FLSP structures. Nickel was an alloyed metal in the SS304.

TABLE 2
EDS chemical composition of
3ML-FLSP on SS304_Cu-Al.

| Element | Atomic Percent |
|---|---|
| Carbon | 8.0 ± 1.0 |
| Nitrogen | 3.0 ± 0.3 |
| Oxygen | 57.6 ± 0.7 |
| Iron | 2.1 ± 0.3 |
| Nickel | 0.2 ± 0.2 |
| Copper | 18.0 ± 0.4 |
| Aluminum | 11.2 ± 1.3 |

FIGS. 11A-11B depict the morphology of the mound before and after cross-sectioning. The three layers of different material are evident in the cross-section. Insignificant melting occurred at the interfaces between the SS304, Cu, and Al layers. A 5-minute ultrasonic bath was sufficient to knock off a fraction of the structures' peaks which suggests that the layers of material are held on by the approximately 1 μm thick redeposited layer on the surface.

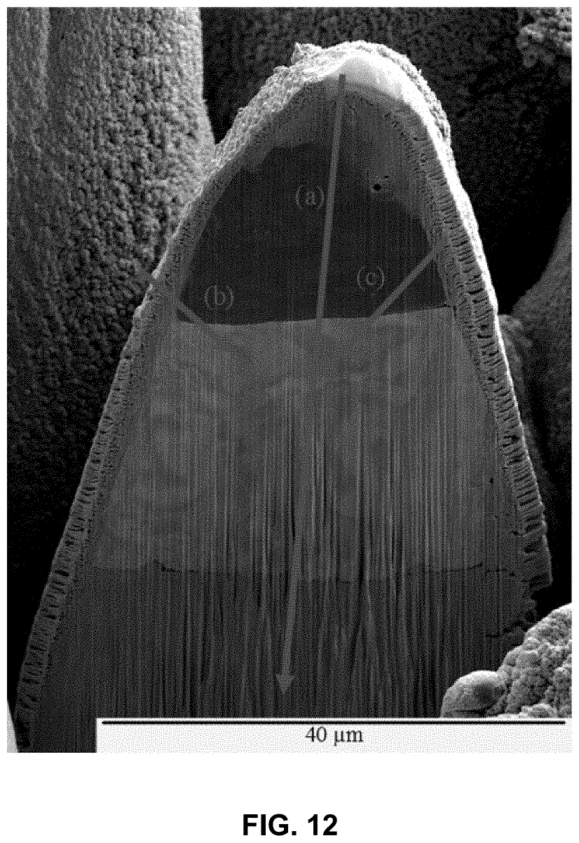

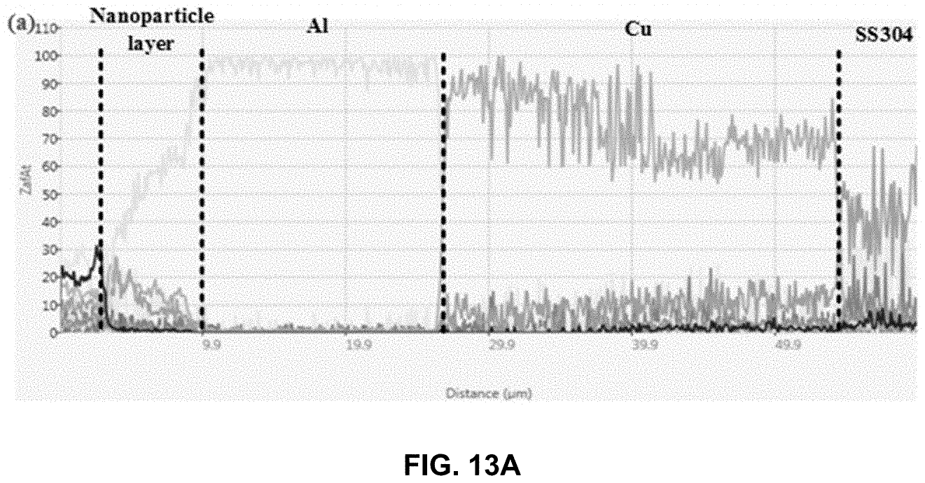

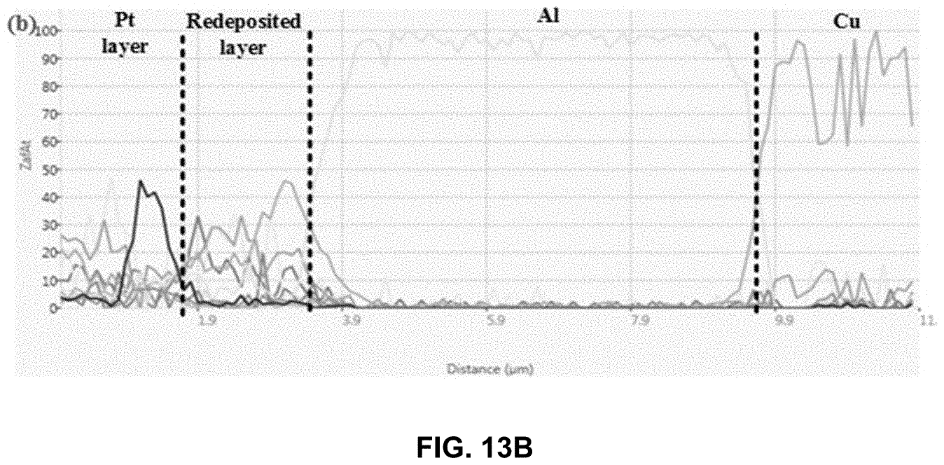

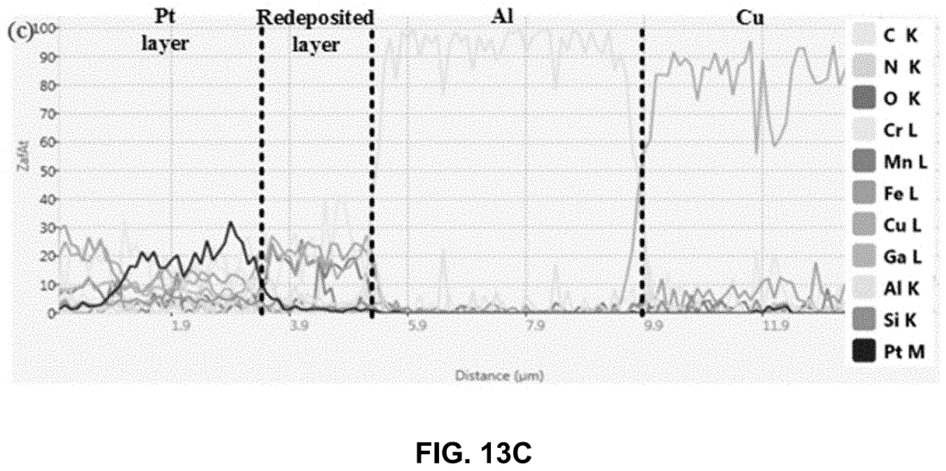

The location and direction of EDS linescans on the cross-section are presented in the SEM image of FIG. 12 and the EDS linescan data in FIGS. 13A-13C. Linescan (a) passes through each material clearly indicating a redeposited layer at the peak, followed by aluminum, copper in the center, and SS304 (implied by the iron content) on bottom. The increase in noise towards the end of scan (a) and decrease in signal intensity around 40 μm is due to shielding caused by the surrounding FLSP structures. Linescan (b) and (c) pass through the redeposited layer on the aluminum substrate and into the copper substrate. Both scans indicate an approximately 2 μm thick redeposited nanoparticle layer composed primarily of aluminum, copper, iron, and oxygen.

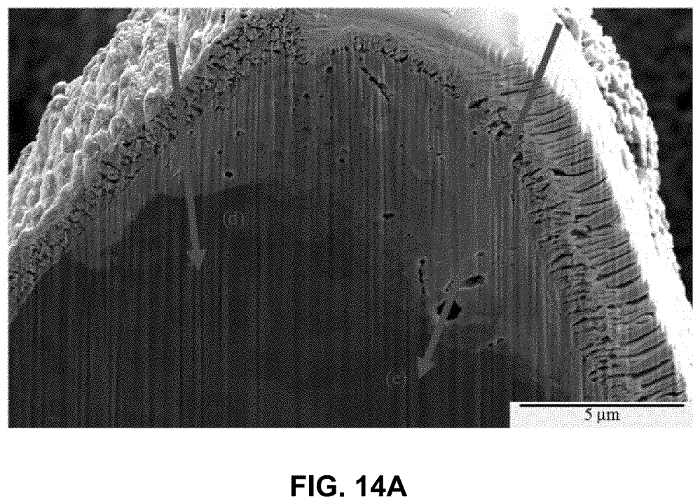

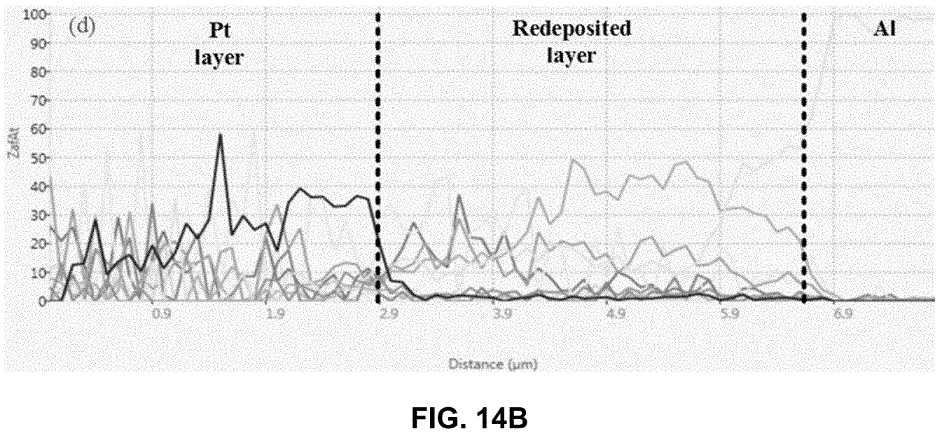

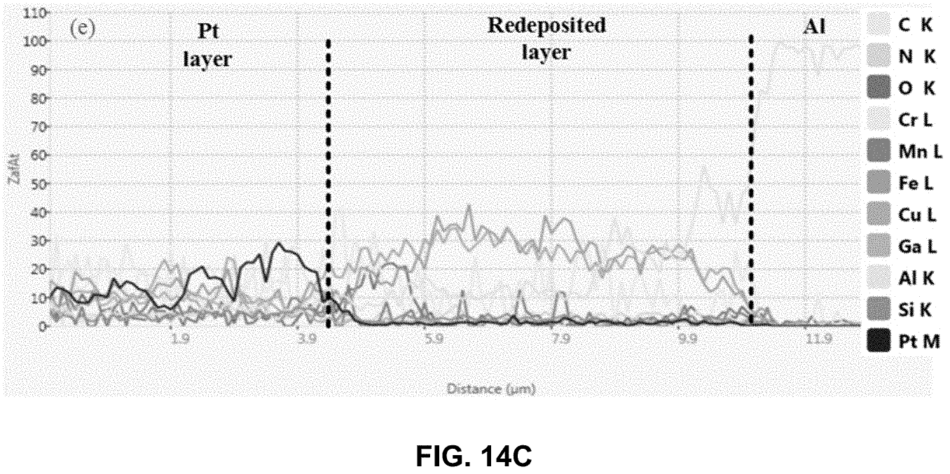

A higher magnification SEM image of the redeposited layer on the structure peak and two EDS linescans through the peak are depicted in FIGS. 14A-14C. Similar to the redeposited layer on the sides of the mound, the peak of the structure is composed aluminum, copper, iron, and oxygen. There was a lack of evidence to suggest the peaks formed from a surface liquid melt or mixing between material layers. This leads us to believe that the peak forms primarily through nanoparticle redeposition. Material is vaporized or nanoparticles are directly ablated from surface during FLSP. The peak formed from material that mixed in the plasma plume and redeposit as a heterogeneous oxide layer.

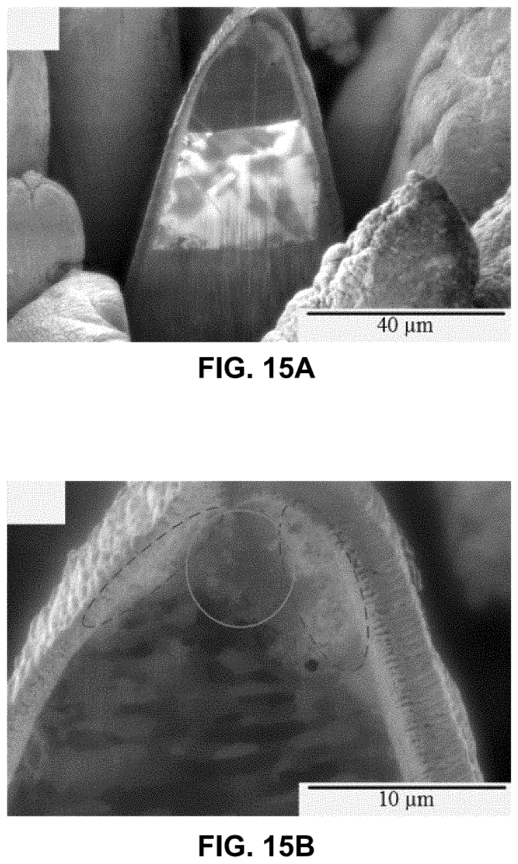

A gallium ion beam imaged the cross section to analyze the subsurface grain structure of the FLSP mound (FIGS. 15A-15B). FIG. 15A shows clear contrast between each material with copper appearing brightest followed by SS304 and aluminum, respectively. FIG. 15B depicts the peak of the structure with no distinguishable grain structure in the redeposited layer. The central region of the peak (blue circle) appears darker than the edges of the peak (dashed red ellipses). Comparing the ion image of FIG. 15B to EDS linescans (a), (d), and (e) of FIGS. 13A-13C and FIGS. 14A-14C, one can see a relationship between the changes in image contrast within the peak and chemical composition. EDS linescan (a) passed through the central region of the peak which is high in aluminum content. Linescan (d) and (e) passed through the brighter regions on the left and right sides of the redeposited layer which were higher in copper content. Similar to the layers of material in FIG. 15A, the copper-rich regions in the redeposited layer appeared brighter than aluminum-rich regions.

3ML-FLSP SS304_Cu_Al Cross Section 2

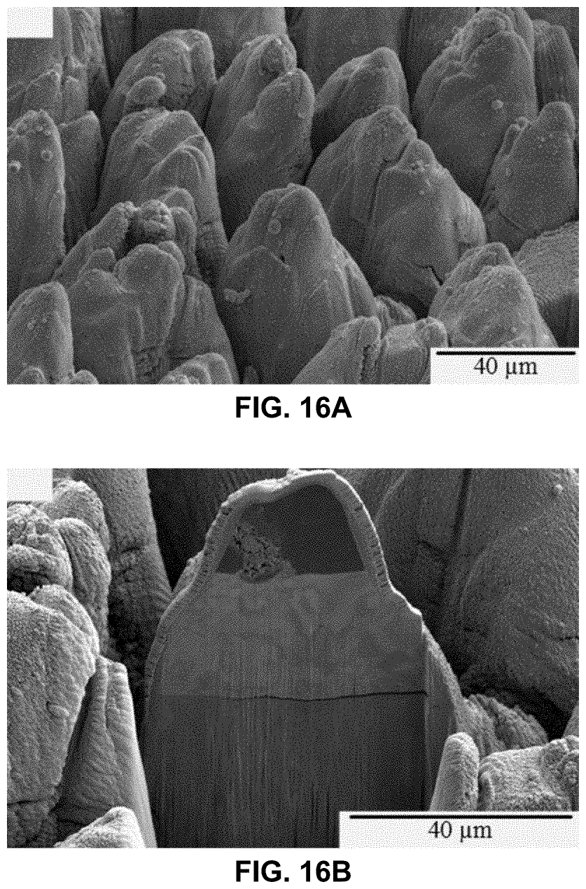

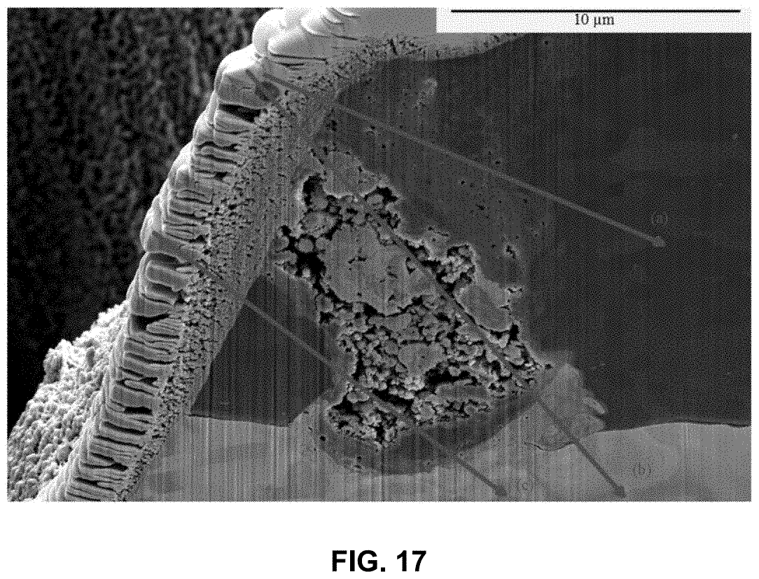

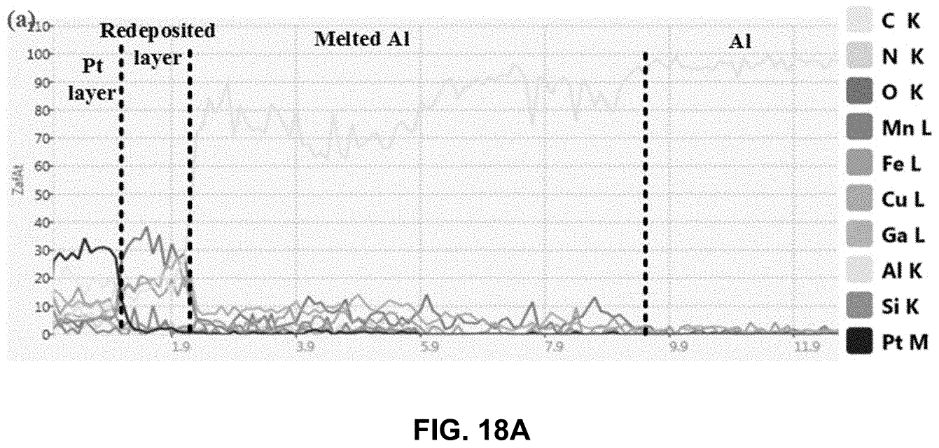

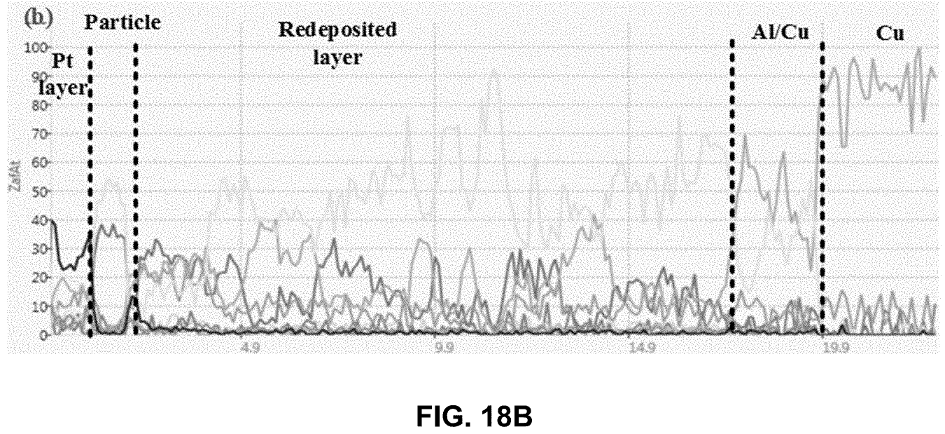

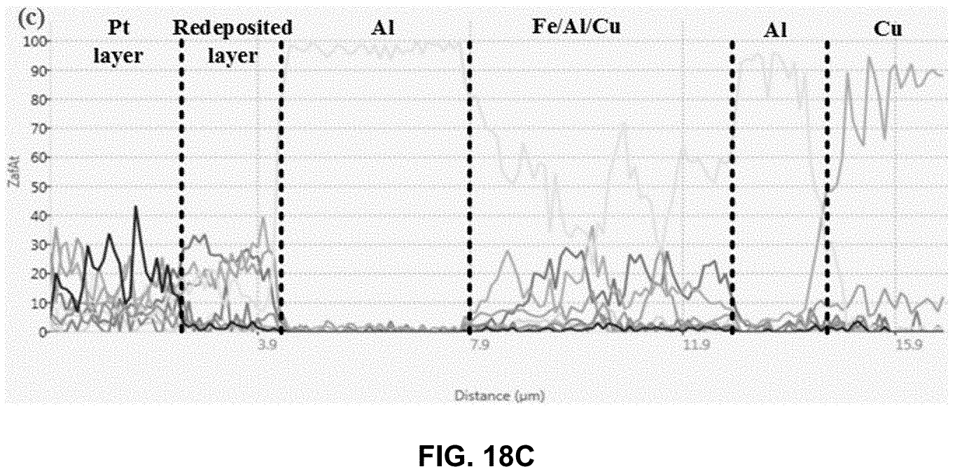

A second mound was cross-sectioned from the same 3ML-FLSP raster. The overall morphology was very similar to the first cross sectioned mound as depicted in FIGS. 16A-16B. Analysis was focused on the voided area in the aluminum layer presented in the higher magnification SEM image with EDS linescan locations in FIG. 17. EDS linescan data is displayed in FIGS. 18A-18C. Linescan (a) passed from the platinum layer through the aluminum above the voided region. The aluminum has an abundance of small pores, a lack of grain structure, and an increase in oxygen content from 2.1 μm to 9.6 μm. The final 3 μm of the scan reached the unprocessed aluminum denoted by the lack of oxygen content and clear grain contrast.

Linescan (b) first passed through an aluminum particle on the surface of the redeposited layer. Afterwards, it passed directly through the voided area for 15 μm. Similar to the redeposited layer, iron, copper, aluminum, and oxygen were found in this region which suggests it formed through redeposition of materials. Starting at 17.4 μm for 2.5 μm was a region mixed with near equal parts aluminum and copper. The SEM image depicted an area that with a “swirl” grain structure which suggested mixing occurred between the aluminum and copper. This assumption was further justified by the lack of a distinct interface between the two layers of material.

Linescan (c) passed through the bottom edge of the void and into the copper layer. The scan passes through a redeposited layer followed by 3.7 μm of aluminum that was not affected by the mixing and close to the voided area. Similar to scan (b), the voided area contained a mixed layer composed of iron, copper, aluminum, and oxygen. After the voided area, starting at 12.3 μm the scan passes through aluminum into the copper. The aluminum copper interface had a small region with mixed composition and the SEM suggests that mixing occurred (<1 μm).

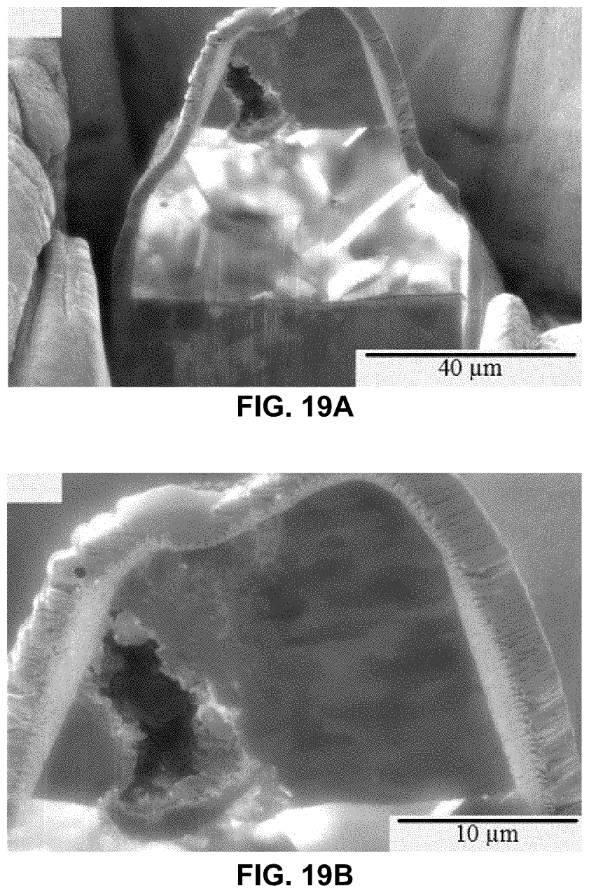

Ion beam images of the cross section are depicted in FIGS. 19A-19B. Similar to the first cross section, the redeposited areas with high copper content appear brighter relative to the regions rich in aluminum or iron. A majority of the redeposited material within the voided area was ablated by the ion beam during imaging.

3ML-FLSP SS304_Aluminum_Copper

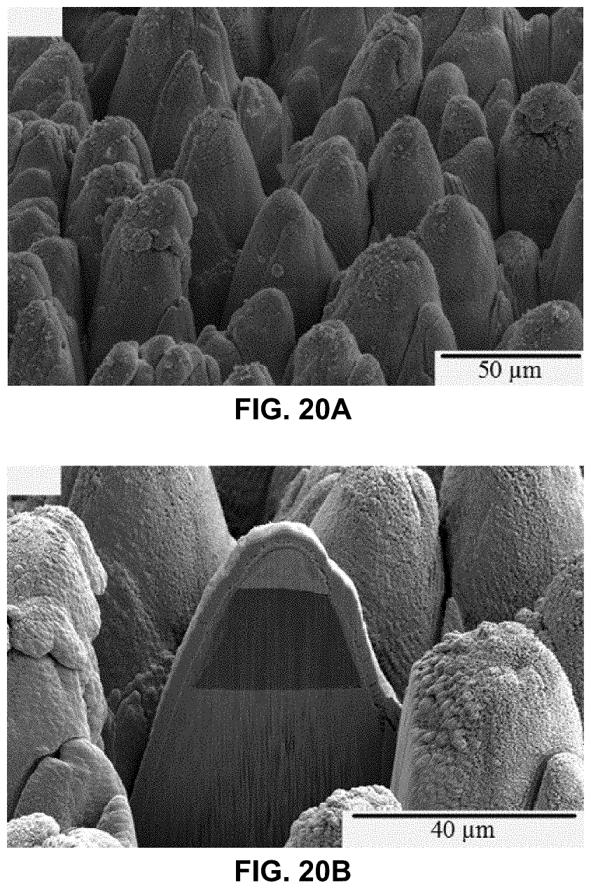

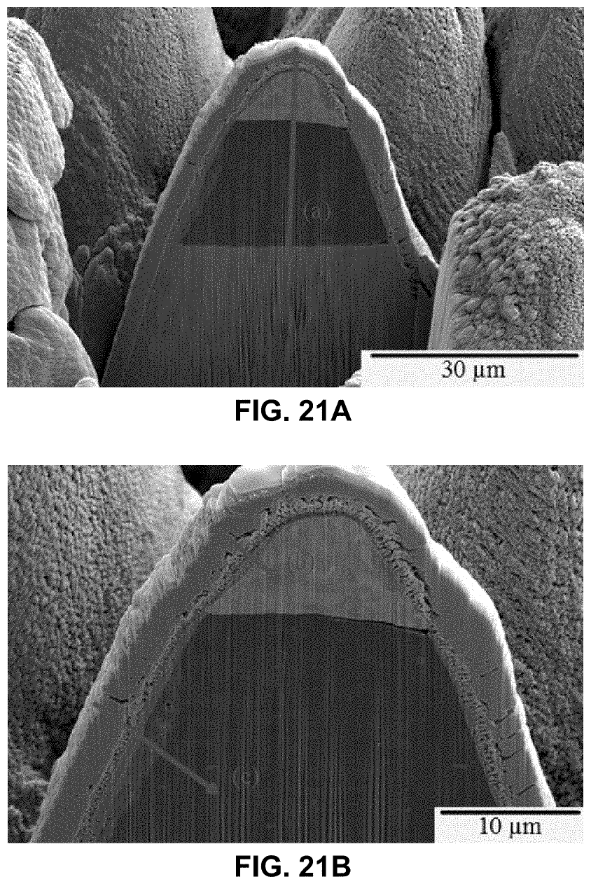

The aluminum and copper layers were interchanged so copper is on the top followed by aluminum and SS304. An overview of the surface and subsurface morphology is depicted in FIGS. 20A-20B.

EDS analysis of the surface of nine different mounds is presented in Error!Reference source not found. 3ML-FLSP on SS304_Al_Cu were chemical uniform as determined by the low standard deviation of each element. EDS results were compared between the two 3ML-FLSP material combinations (Error! Reference source not found. and Error! Reference source not found., respectively). Both rasters contained nearly identical amounts of carbon (8.0% and 8.1%, respectively) and nitrogen (3.0% and 2.9%, respectively) from contamination due to exposure to the atmosphere. Oxygen content was incorporated in the redeposited layer in comparable amounts (57.6% and 59.9%, respectively). Nickel content expectedly increased proportional to the iron content because nickel is one of the alloyed metals in SS304.

TABLE 3
EDS chemical composition of
3ML-FLSP structures on SS304_Al_Cu.

| Element | Atomic Percent |
|---|---|
| Carbon | 8.1 ± 0.5 |
| Nitrogen | 2.9 ± 0.5 |
| Oxygen | 59.9 ± 1.3 |
| Iron | 4.3 ± 0.9 |
| Nickel | 0.5 ± 0.3 |
| Copper | 3.9 ± 0.8 |
| Aluminum | 20.0 ± 2.1 |

The metal in the middle layer of the 3ML-FLSP structures always had the highest content of the three layers. SS304_Cu_Al had a copper content of 18.0% while the iron and aluminum in this sample were 2.1% and 11.2%, respectively. SS304_Al_Cu had an aluminum content of 20.0% while iron and copper in this sample were 4.3% and 3.9%, respectively. More material from the top layer of the 3ML-FLSP structures is ablated relative to the middle and bottom layers which would decrease the thickness and overall content of the top layer relative to the other two. In addition, the electron beam interacts with the surface in the top tens of microns which would decrease the signal from the materials in the bottom layer.

The FLSP mound clearly had three layers of different materials. The redeposited layer was approximately a micron thick over the entire surface of the mound. Similar to the 3ML-FLSP on SS304_Cu_Al, insignificant melting and mixing occurred at the layer interfaces.

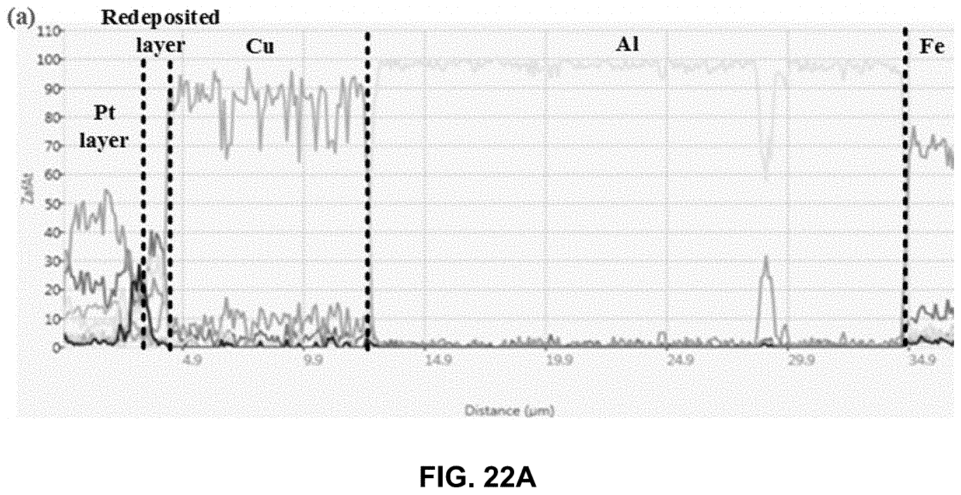

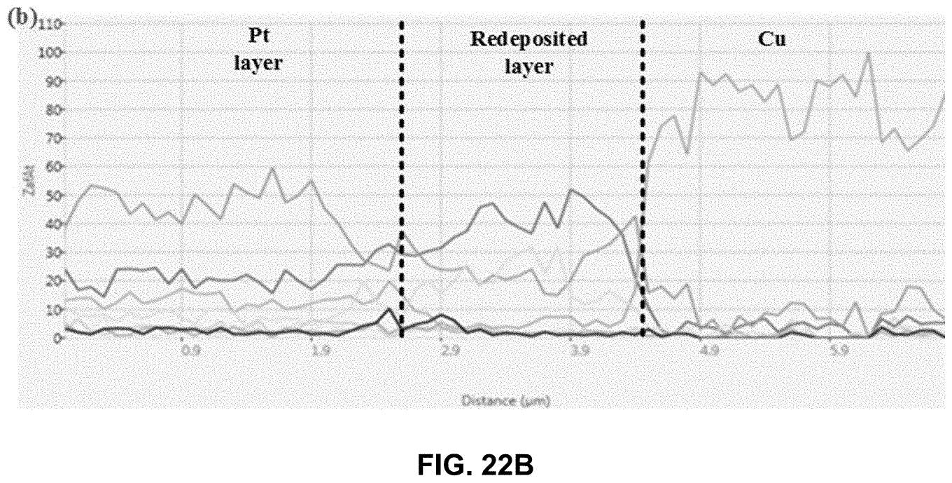

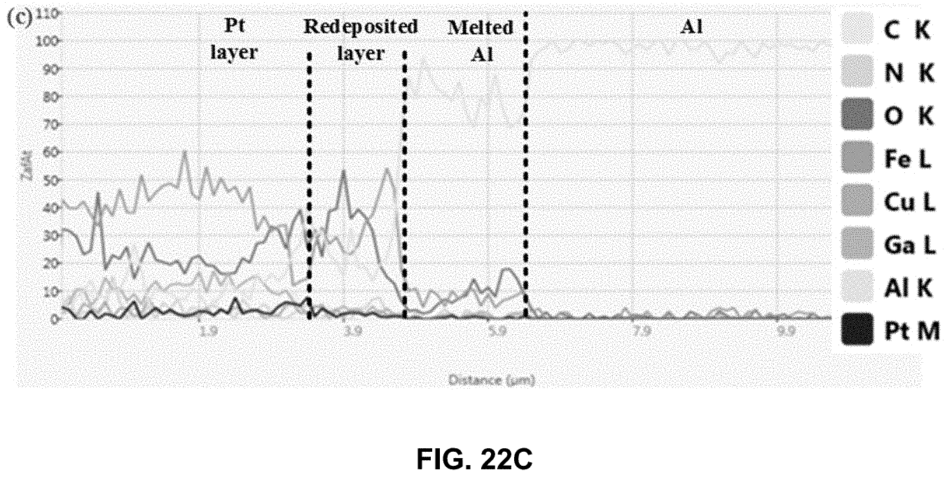

Linescan (a) of FIGS. 22A-22C passed vertically through the center of the mound. The copper and aluminum layers were 8 μm and 22.5 μm thick, respectively. Scan (b) passes through the redeposited layer on the side of the copper peak. Insignificant copper is found in the redeposited layer which is composed primarily of aluminum, iron, and oxygen. Scan (c) passes from through the redeposited layer into the aluminum substrate on the side of the mound. The redeposited layer, similar to scan (b) is composed of aluminum, iron, and oxygen while it lacks copper. A 1.8 μm thick region of melted aluminum formed beneath the redeposited layer. Melting is suspected to be the cause of this region due to the decrease in aluminum content relative to the center of the aluminum layer, voiding, and the change in grain structure.

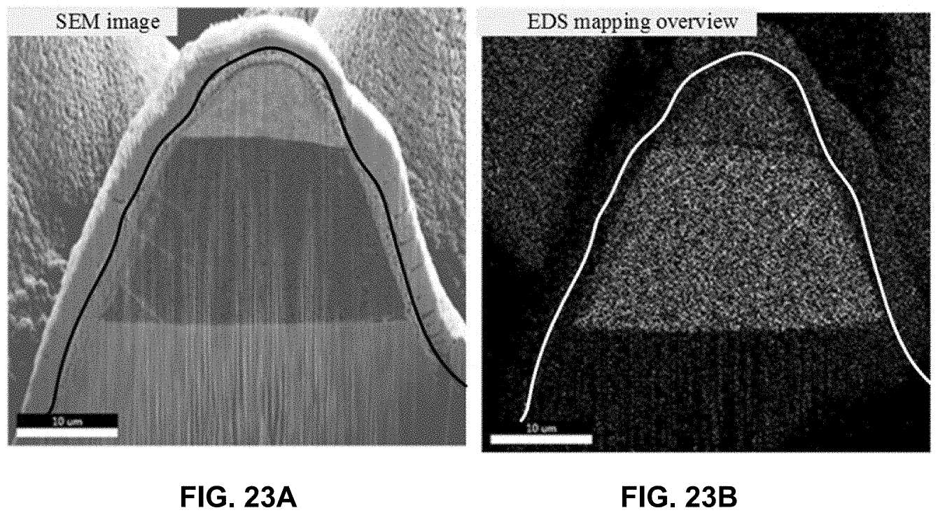

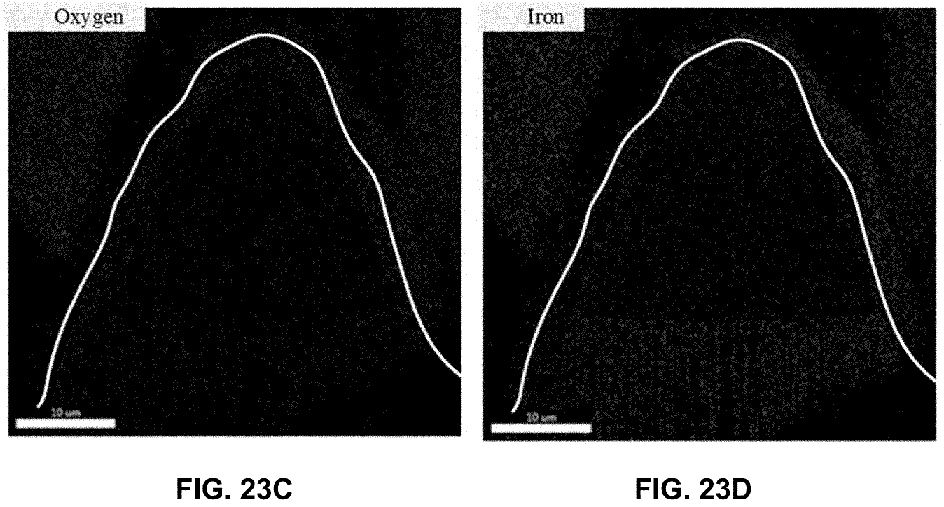

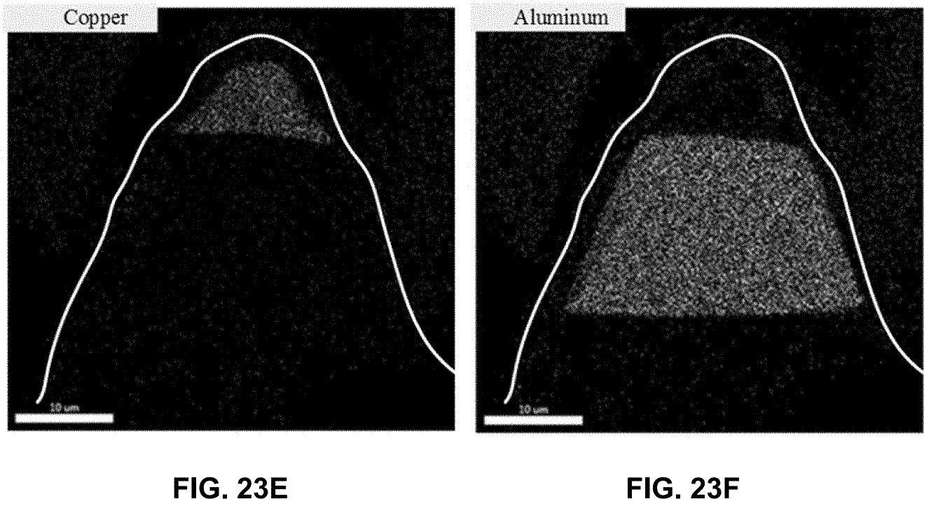

A different method to perform EDS scans on FLSP mounds involved elemental mapping of the full cross-sectioned surface. Our group has not utilized this technique but it was useful to determine how the material was redistributing itself during FLSP. The EDS mapped mound is depicted in FIGS. 23A-23F. FIGS. 23A and 23B depict an SEM image and an overview of all of the elements mapped on one image, respectively. FIGS. 23C-23F display the four major elements of interest: oxygen, iron, copper, and aluminum. All data points that are not located on the cross section can be ignored (i.e. any signal from the surrounding mounds). The outline of the FLSP structure is overlaid on each image. Oxygen was mapped to the outer perimeter of the mound surface. Iron and aluminum was apparent within their respective layers as well as mixed in with oxygen in the redeposited layer on the peak and sides of the mound. Copper content was primarily within the copper peak but small amounts were located in the redeposited layer along the left side of the aluminum layer. Results from EDS mapping were in agreement with the EDS linescans although further optimization of EDS map scan parameters may be useful to improve the accuracy.

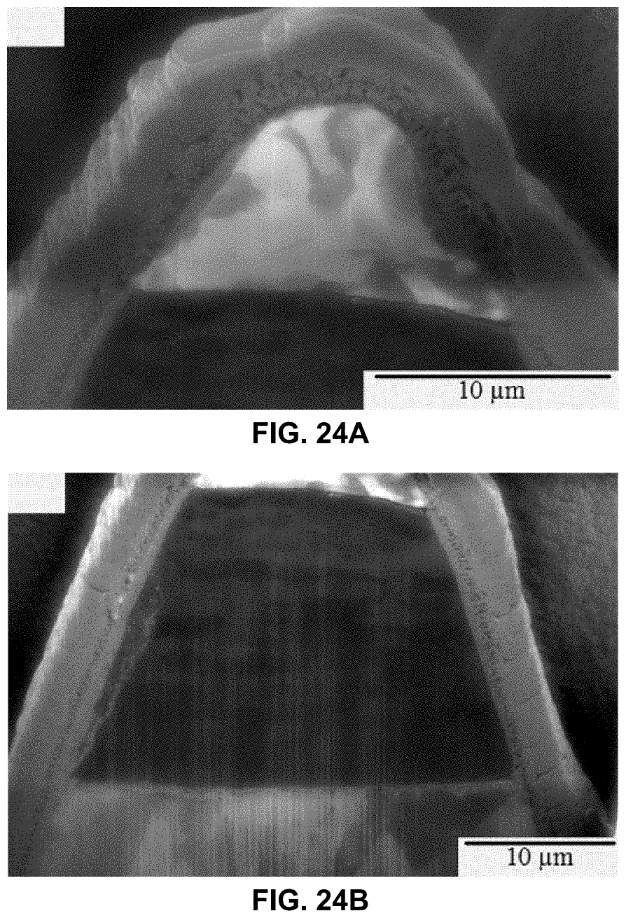

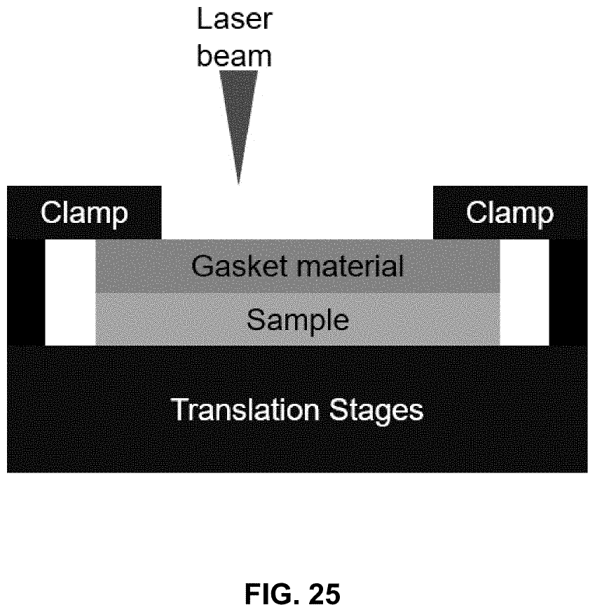

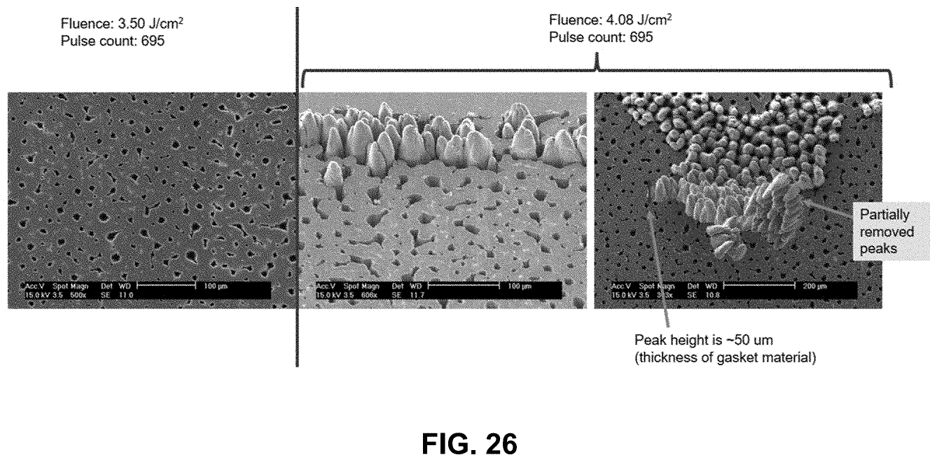

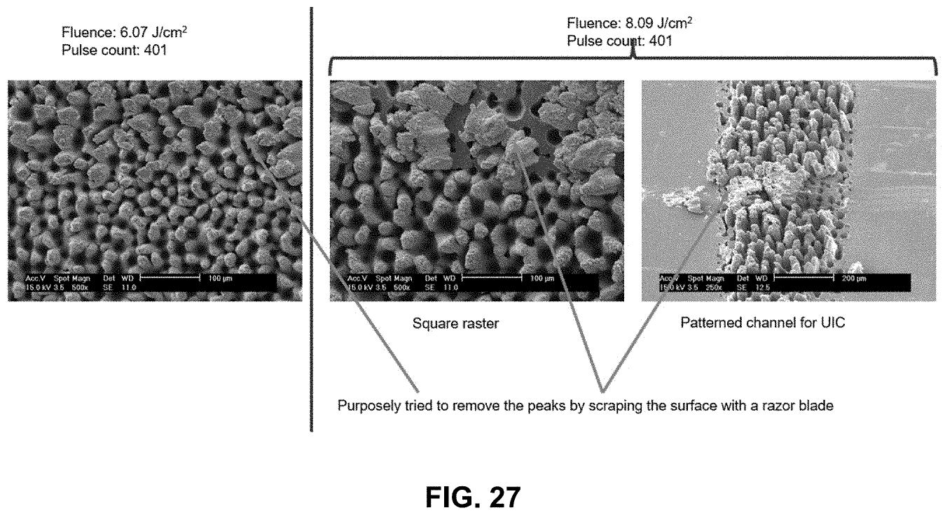

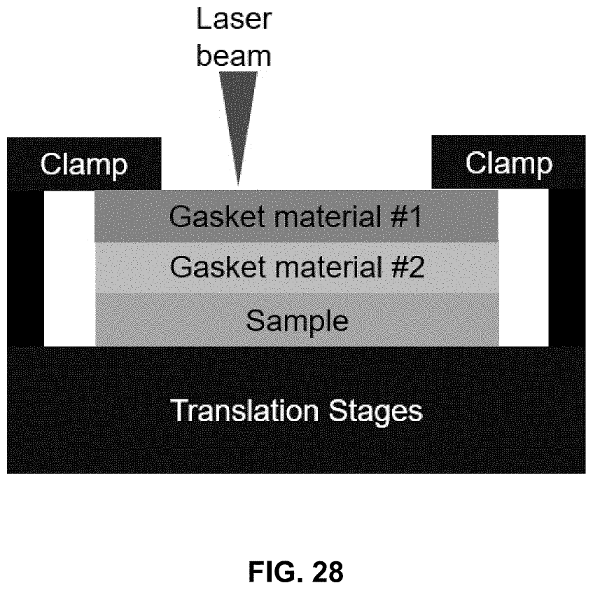

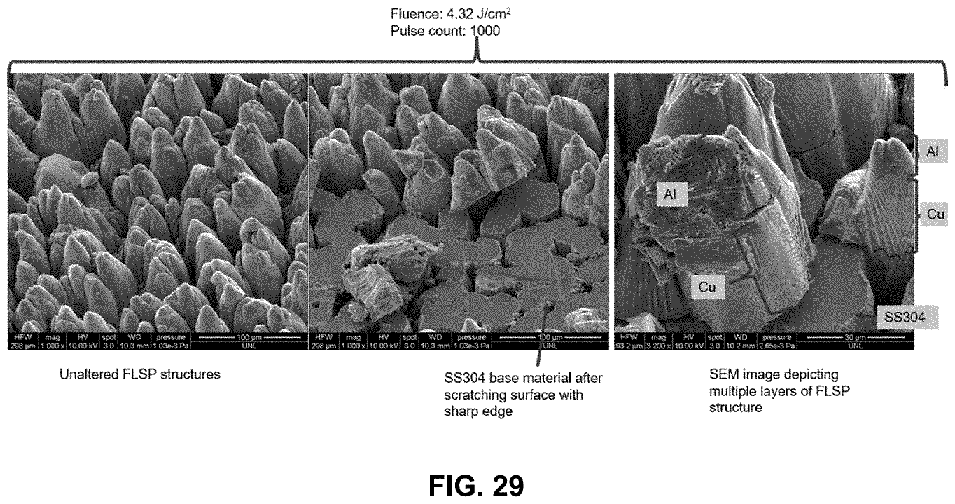

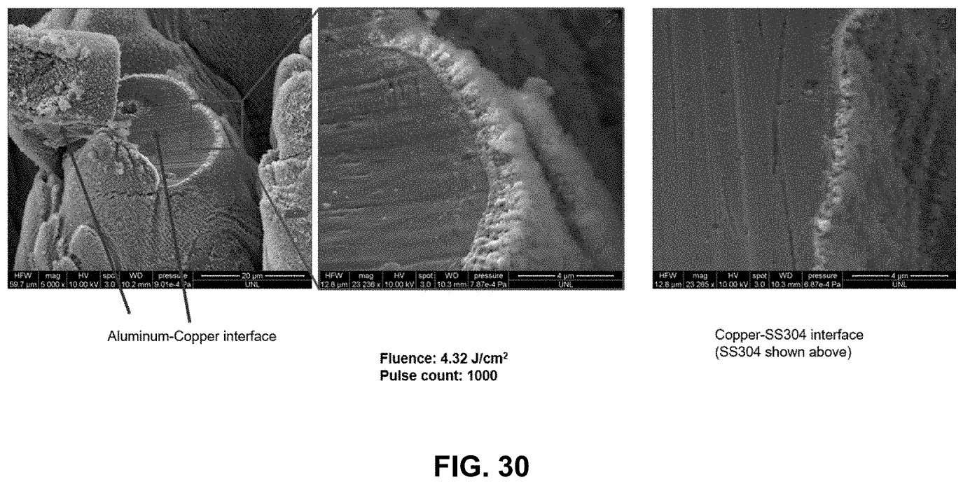

The grain contrast was depicted in the ion beam images of FIGS. 24A-24B. These images confirmed that the copper, aluminum, and SS304 layers were not melted together due to the distinct contrast between each material. Regions with varying contrast developed along the sides of the mound related to the redeposited layer and melted aluminum layer analyzed in the EDS linescans of FIGS. 22A-22C.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including any polymorphs, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Every device, system, material, layer, combination of materials or layers, and method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A method for forming a plurality of microfeatures, the method comprising:
irradiating a starting multi-layer material with a pulsed laser beam at a plurality of locations of the multi-layer material; wherein:
the starting multi-layer material comprises a plurality of starting layers comprising a first starting layer having a first composition and a second starting layer adjacent to the first starting layer and having a second composition different than the first composition;
the plurality of microfeatures form in the multi-layer starting material during the step of irradiating;
each microfeature comprises a plurality of microfeature layers comprising a first microfeature layer having the first composition and a second microfeature layer having the second composition.

2. The method of claim 1, wherein the plurality of starting layers comprises a third starting layer adjacent to the second starting layer and having a third composition different than each of the first composition and the second composition; wherein the plurality of microfeature layers comprises a third microfeature layer having the third composition; and wherein the second microfeature layer is in between the first microfeature layer and the third microfeature layer.

3. The method of claim 1, wherein each of the plurality of starting layers or each of the plurality of starting layers other than the first layer has a thickness selected from the range of 1 μm to 500 μm; and wherein each microfeature layer, other than a surface-redeposited layer, if present, has a thickness selected from the range of 1 μm to 500 μm.

4. The method of claim 1, wherein each starting layer's composition is a metal alloy, metal oxide, dielectric material, glass, one or more allotropes of carbon (such as carbon fiber), ceramic, semiconductor, or any combination of these.

5. The method of claim 1, wherein each of the first composition, second composition, and third composition is selected from the group consisting of: iron, an iron containing metal alloy, steel, stainless steel, copper, aluminum, platinum, silver, gold, nickel, zinc, and any combination of these.

6. The method of claim 1 comprising scanning the pulsed laser beam on the multi-layer during the step of irradiating thereby exposing the plurality of locations to the pulsed laser beam.

7. The method of claim 1, wherein the pulsed laser beam is characterized by a pulse frequency selected from the range of 1 Hz to 100 MHz, a pulse energy selected from the range of 1 nJ to 30 J, a fluence selected from the range of 0.01 J/cm² to 100 J/cm², a pulse length selected from the range of 1 fs to 100 ns, and/or an average spot size selected from the range of 1 μm to 1 cm.

8. The method of claim 1, wherein formation of the plurality of microfeatures during the step of irradiating comprises ablation of portions of the starting multi-layer material that surround the microfeatures.

9. The method of claim 1, wherein each microfeature has a peak-to-valley height selected from the range of 1 μm to 500 μm.

10. The method of claim 1, wherein the microfeatures are arranged as an array on a substrate, the substrate comprising the first composition.

11. The method of claim 1, wherein an interface between any two microfeature layers is compositionally abrupt or comprises an interfacial layer; wherein the interfacial layer has thickness less than 10 μm and has an interfacial composition comprising a mixture of a composition of each of the microfeature layers adjacent to the interfacial layer.

12. The method of claim 1, wherein each microfeature comprises a surface redeposited-layer having a redeposited-layer composition; wherein the surface composition comprises oxygen and a composition from a microfeature layer adjacent to the surface redeposited-layer; and wherein the surface redeposited-layer is formed by redeposition of an ablated or vaporized material during the step of irradiating.

13. The method of claim 1 comprising removing at least one starting layer after the step of irradiating is complete; wherein at least one starting layer is remained in the starting material during the step of removing; wherein removing at least one starting layer comprises removing at least a portion of the microfeatures; and wherein remaining one or more starting layers comprise cavities formed by the pulsed laser beam during the step of irradiating.

14. The method of claim 1 comprising removing at least one starting layer after the step of irradiating is complete; wherein removing at least one starting layer comprises removing a topmost starting layer; wherein the at least one remaining starting layer is free of a re-deposited surface layer in regions free of the microfeatures.

15. The method of of claim 1 comprising removing or isolating the plurality of microfeatures.

16. A microfeature comprising:
three or more microfeature layers, each microfeature layer have a composition different from that of each other microfeature layer; the three or more microfeature layers comprising:
a first microfeature layer having a first composition;
a second microfeature layer having a second composition; wherein the second microfeature layer is directly adjacent to the first microfeature layer or is separated from the first microfeature layer by an interfacial layer having a thickness less than 10 μm; and
a third microfeature layer having a third composition; wherein the second microfeature layer is in between the first and third microfeature layers; wherein the third microfeature layer is directly adjacent to the second microfeature layer or is separated from the second microfeature layer by an interfacial layer having a thickness less than 10 μm.

17. The microfeature of claim 16 being (a) attached to, bound to, or otherwise on a substrate or being (b) free of a substrate.

18. A plurality of microfeatures of claim 16, the plurality of microfeatures being arranged as an array on the substrate or being in the form of a powder free of a substrate.

19. A material comprising a plurality of microfeatures, each microfeature being according to claim 16, the composition further comprising:
one or more first regions being free of the microfeatures, wherein a surface of the one or more first regions is hydrophobic or hydrophilic; and
one or more second regions comprising the microfeatures, wherein a surface of the one or more second regions is the other of hydrophobic or hydrophilic.

20. A method for forming a plurality of cavities, the method comprising:
irradiating a starting multi-layer material with a pulsed laser beam at a plurality of locations of the multi-layer material; wherein:
the starting multi-layer material comprises a plurality of starting layers comprising a first starting layer having a first composition and a second starting layer adjacent to the first starting layer and having a second composition different than the first composition;
the step of irradiating comprises forming a plurality of cavities in at least one starting layer via ablation of the at least one starting layer by the pulsed laser beam.
